(19) United States
(12) Patent Application Publication
(10) Pub. No.: US 2006/0192492 A1
(43) Pub. Date: Aug. 31, 2006

(54) Display panel

(76) Inventors: Nobuyuki Ushifusa, Yokohama (JP); Nobuhiko Fukuoka, Ebina (JP); Shigeru Matsuyama, Mobara (JP); Hiroshi Kawasaki, Ohami-Shirasato (JP); Chikae Kubo, Mobara (JP); Akira Ishii, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/362,710

(22) Filed: Feb. 28, 2006

(30) Foreign Application Priority Data
Feb. 28, 2005 (JP) 2005-052736

(51) Int. Cl. H05B 39/00

(52) U.S. Cl. 315/161

(57) ABSTRACT

In a display panel each of whose pixels has an electron emission element equipped with a pair of electrodes and an insulation area isolating these electrodes, the present invention specifies that the power supply line (scan line) connected with one of the pair of electrodes shall be formed thicker than the other electrode by screen printing using silver (Ag) paste or the like, and the power supply line and the one of the electrodes shall be connected together through an intermediary of the auxiliary electrode formed thinner than the power supply line, whereby a resistance of the power supply line is decreased, a voltage drop in the one electrode is controlled, and reliability of electrical connection between the power supply line and the one electrode is heightened.

The present application claims priority from Japanese application JP 2005-052736 field on Feb. 28, 2005, the content of which is hereby incorporated by reference into this application.

### BACKGROUND OF THE INVENTION

1. Field of the Invention

This invention relates to a display panel of a display, especially to a display panel of a display equipped with electron emission elements (electron emission sources) for respective pixels, typified by the electron field emission display.

2. Description of the Related Art

JP 2004-111053 (and its counterpart USP 2004/017160) discloses a display panel (an FED panel) used for the field emission display. This FED panel has a configuration, as shown FIG. 27, such that at each portion where a signal line (data line) 11 intersects a scan line 27, the signal line 11, insulating layers 14, 15, the scan line 27, and an upper electrode 13 are laminated in this order on a substrate 10. An electron source is an MIM (Metal-Insulator-Metal) type electron source in which a metal-insulator-metal structure consisting of the upper electrode 13, an insulating layer (electron acceleration layer) 12, and the lower electrode (signal line) 11 is formed.

### SUMMARY OF THE INVENTION

In order to achieve enlargement of the FED, it is necessary to reduce brightness unevenness along scan lines by controlling voltage drops occurring along the scan lines. That is, in order to inhibit the voltage effect, lower resistance of the scan lines is desired.

The object of this invention is to provide a technology of achieving lower resistance of wirings in a display panel such that a plurality of wirings are formed on a substrate.

In the FED panel according to the present invention, the thickness of the scan lines that are power supply lines (electricity supplying wirings) is thickened to decrease the resistance value and control the voltage drop.

However, if the thickness of the scan line is thickened, there is a case where a failure may arise in conduction between the scan line 27 and the upper electrode 13, as designated by a symbol P in FIG. 2. Especially in the case where scan lines 27 are made by the screen printing method, coarse surfaces thereof make them prone to failures in connection between them and the upper electrodes 13 that are thin films.

Consequently, between the electrodes of the electron sources and the power supply lines for supplying electric power to the electrodes, the display panel according to the present invention is equipped with connecting auxiliary electrodes for establishing conduction between the electrodes and the power supply lines.

Specifically, the aspect of this invention is directed to a display panel of the field emission display, comprising electrodes of the electron sources and power supply lines for supplying electric power to the electrodes, wherein a connecting auxiliary electrode for establishing conduction between the electrode and the power supply line is provided between the electrode and the power supply line.

### BRIEF DESCRIPTION OF THE DRAWINGS

FIG. 1 is a cross-sectional view of a display panel of the field emission display according to a first embodiment;

FIG. 2 is a view for explaining connection failure;

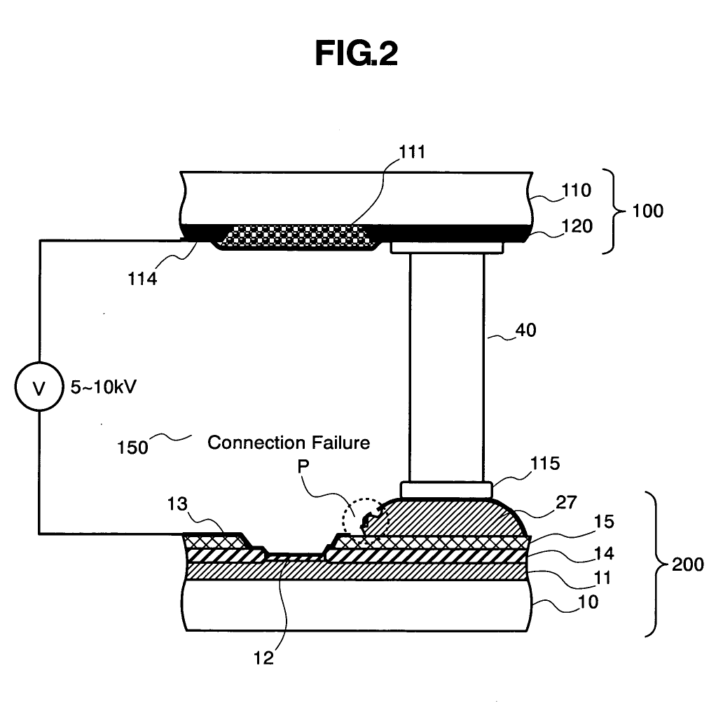

FIG. 3 is a manufacturing process diagram of the FED panel of the first embodiment;

FIG. 4 is a manufacturing process diagram (continued from FIG. 3) of the FED panel of the first embodiment;

FIG. 5 is a manufacturing process diagram (continued from FIG. 4) of the FED panel of the first embodiment;

FIGS. 6A-6C show a structure on a substrate (cathode substrate) in Step (b) (see FIG. 3) of the first embodiment, FIG. 6A is a plan view of the substrate, FIG. 6B is a cross-sectional view taken along line A-A′ of FIG. 6A, and FIG. 6C is a cross-sectional view taken along line B-B′ of FIG. 6A;

FIGS. 7A-7C show a structure on the substrate in Step (f) (see FIG. 3) of the first embodiment, FIG. 7A is a plan view of the substrate, FIG. 7B is a cross-sectional view taken along line A-A′ of FIG. 7A, and FIG. 7C is a cross-sectional view taken along line B-B′ of FIG. 7A;

FIGS. 8A-8C show a structure on the substrate in Step (i) (see FIG. 3) of the first embodiment, FIG. 8A is a plan view of the substrate, FIG. 8B is a cross-sectional view taken along line A-A′ of FIG. 8A, and FIG. 8C is a cross-sectional view taken along line B-B′ of FIG. 8A;

FIGS. 9A-9C show a structure on the substrate in Step (k) (see FIG. 3) of the first embodiment, FIG. 9A is a plan view of the substrate, FIG. 9B is a cross-sectional view taken along line A-A′ of FIG. 9A, and FIG. 9C is a cross-sectional view taken along line B-B′ of FIG. 9A;

FIGS. 10A-10C show a structure on the substrate in Step (i) and Step (I′) (see FIG. 4) of the first embodiment, FIG. 10A is a plan view of the substrate, FIG. 10B is a cross-sectional view taken along line A-A′ of FIG. 10A, and FIG. 10C is a cross-sectional view taken along line B-B′ of FIG. 10A;

FIGS. 11A-11C show a structure on the substrate in Step (n) (see FIG. 4) of the first embodiment, FIG. 11A is a plan view of the substrate, FIG. 11B is a cross-sectional view taken along line A-A′ of FIG. 11A, and FIG. 11C is a cross-sectional view taken along line B-B′ of FIG. 11A;

FIGS. 12A-12C show a structure on the substrate in Step (a) (see FIG. 4) of the first embodiment, FIG. 12A is a plan view of the substrate, FIG. 12B is a cross-sectional view taken along line A-A′ of FIG. 12A, and FIG. 12C is a cross-sectional view taken along line B-B′ of FIG. 12A;

FIGS. 13A-13C show a structure on the substrate in Step (x) (see FIG. 5) of the first embodiment, FIG. 13A is a plan view of the substrate, FIG. 13B is a cross-sectional view taken along line A-A′ of FIG. 13A, and FIG. 13C is a cross-sectional view taken along line B-B′ of FIG. 13A;

FIGS. 14A-14C show a structure on the substrate in Step (z) (see FIG. 5) of the first embodiment, FIG. 14A is a plan view of the substrate, FIG. 14B is a cross-sectional view taken along line A-A′ of FIG. 14A, and FIG. 14C is a cross-sectional view taken along line B-B′ of FIG. 14A;

FIGS. 15A-15C show a structure of a display side substrate (anode substrate) of the FED panel of the first embodiment, FIG. 15A is a plan view of the substrate, FIG. 15B is a cross-sectional view taken along line C-C′ of FIG. 15A, and FIG. 15C is a cross-sectional view taken along line D-D′ of FIG. 15A;

FIGS. 16A and 16B show a cross sectional structure of the FED panel of the first embodiment, FIG. 16A is a cross-sectional view taken along line A-A′ of the FED panel shown in FIG. 17, and FIG. 16B is a cross-sectional view taken along line D-D′ of FIG. 17;

FIG. 17 is a plan view of the FED panel of the first embodiment in which pixels (electron sources) are arranged with (6, 6) dots on a substrate principal surface;

FIG. 18 is a cross-sectional view of an FED panel of a second embodiment;

FIG. 19 is a manufacturing process diagram of the FED panel of the second embodiment;

FIG. 20 is a manufacturing process diagram (continued from FIG. 19) of the FED panel of the second embodiment;

FIGS. 21A-21C show a configuration on a substrate (cathode substrate) used for a display of a third embodiment, FIG. 21A is a plan view of the substrate, FIG. 21B is a cross-sectional view taken along line A-A′ of FIG. 21A, and FIG. 21C is a cross-sectional view taken along line B-B′ of FIG. 21A;

FIGS. 22A and 22B show a configuration of the display (FED panel) of the third embodiment, FIGS. 22A and 22B show a configuration on the display (FED panel) of the third embodiment, FIG. 22A is a cross-sectional view taken along line B-B′ of FIG. 21A, and FIG. 22B is a cross-sectional view taken along line A-A′ of FIG. 21A;

FIG. 23 is a manufacturing process diagram of the FED panel of the third embodiment;

FIG. 24 is a manufacturing process diagram (continued from FIG. 23) of the FED panel of the third embodiment;

FIG. 25 is a manufacturing process diagram of an FED panel of a fourth embodiment;

FIG. 26 is a manufacturing process diagram (continued from FIG. 25) of the FED panel of the fourth embodiment; and

FIG. 27 is a cross-sectional view of an FED panel according to the conventional example.

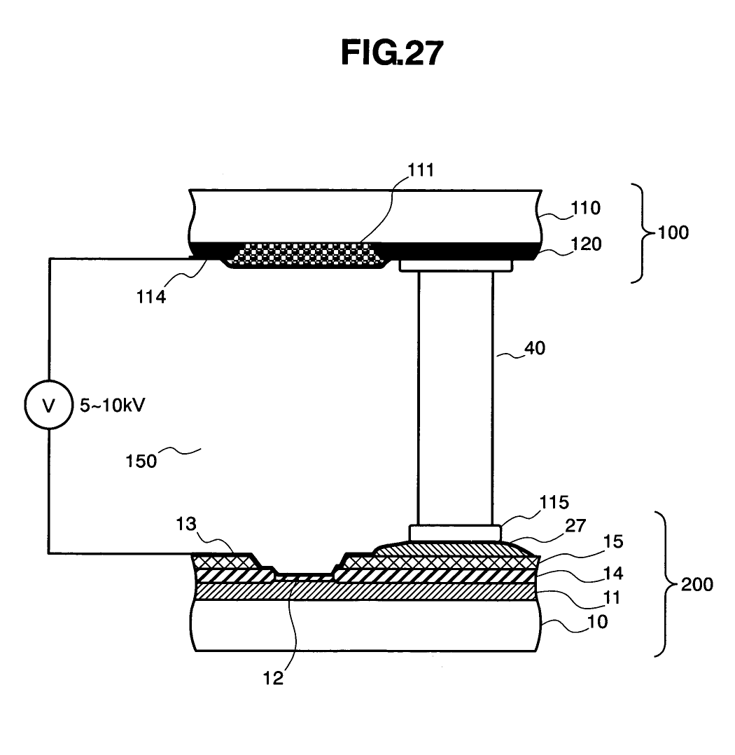

### DETAILED DESCRIPTION

Hereafter, an FED (Field Emission Display) panel to which this invention was applied, and its manufacturing method will be described.

### FIRST EMBODIMENT

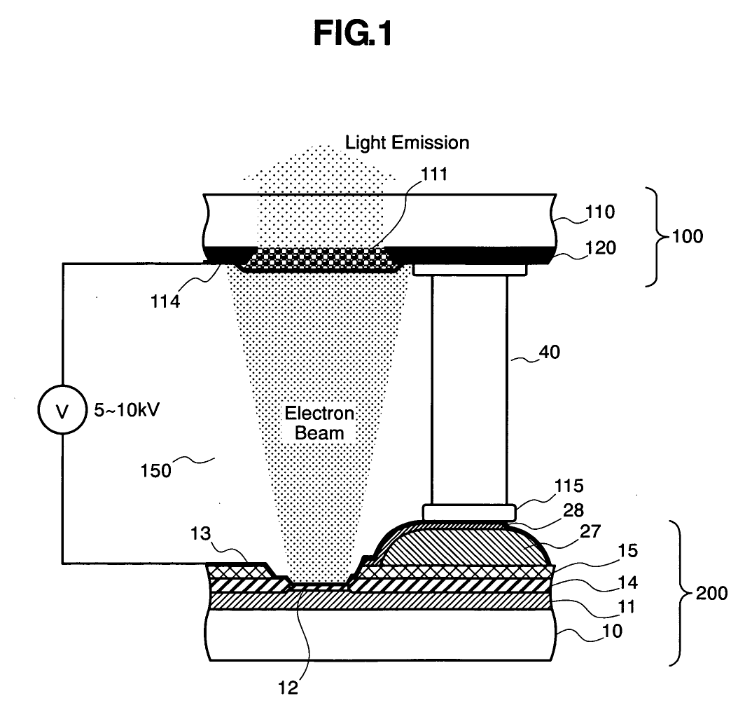

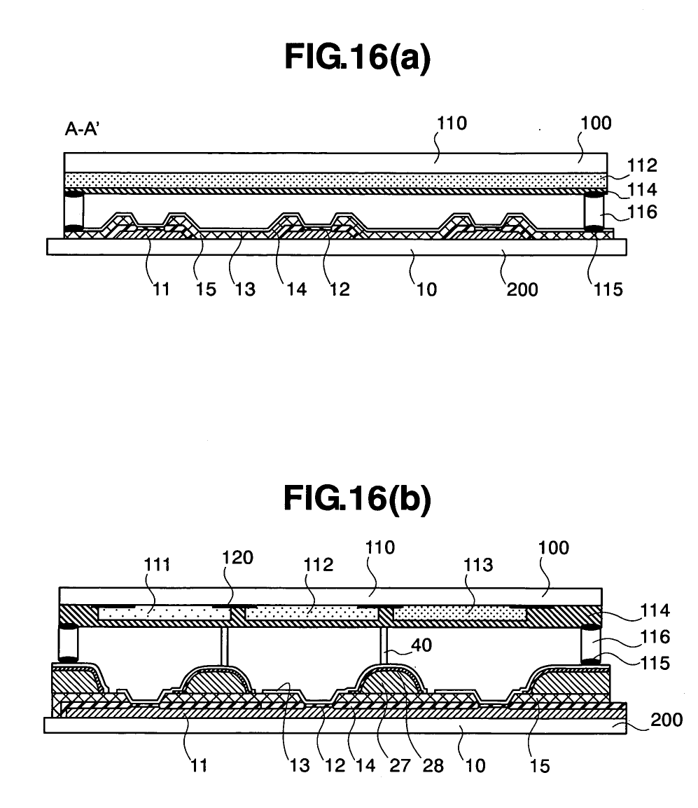

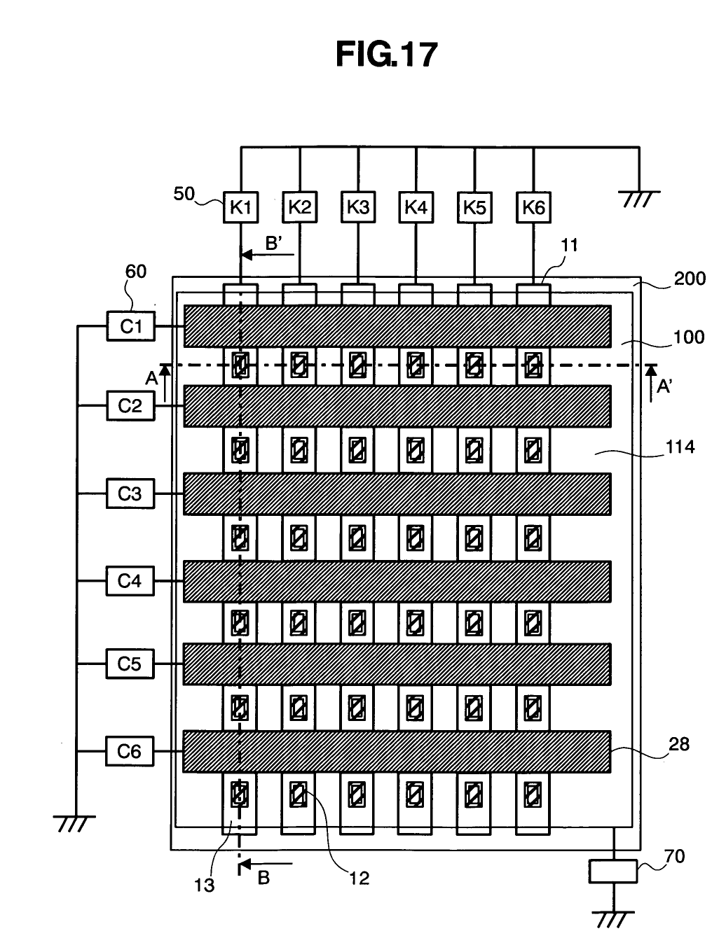

First, the FED panel of this embodiment will be described using FIG. 1, FIG. 16, and FIG. 17.

FIG. 17 is a plan view of the FED panel of this embodiment, the figure showing the FED panel to which drive circuits 50, 60 are connected. Note that FIG. 17 shows a plan view seen from the display side with a part thereof omitted to facilitate understanding of the FED panel.

FIG. 16A is a cross-sectional view taken along line A-A′ in the FED panel of FIG. 17. FIG. 16B is a cross-sectional view taken along line B-B′ in the FED panel of FIG. 17. As will be described later, each of pixels of the FED panel (display) according to this embodiment is equipped with an electron source formed by laminating a first electrode (lower electrode) 11, an insulating layer (electron acceleration layer) 12, and a second electrode (upper electrode) 13 in this order on a substrate 10. In FIG. 17, the lower electrode 11 is formed as six signal lines (data lines) extended in a longitudinal direction. Moreover, in FIG. 17, each of the upper electrode 13 is electrically connected with one of 6 second signal lines 28 extending in a transverse direction and faces one of the lower electrodes (the first data lines) 11 through an intermediary of the insulating film 12. Therefore, in the FED panel of FIG. 17, electron sources (shown as the insulation film/electron acceleration layer 12) each of which emits electrons by a potential difference between one of the six first signal lines and one of the six second signal lines are arranged in a matrix of six rows by six columns. That is, FIG. 17 shows the FED panel in which pixels each having the 6×6 dots were formed on the substrate principal surface. The arrangement of pixels like this is sometimes written as (6, 6) dots. In contrast to this, FIGS. 16A and 16B show a cross section of the FED panel in concern as 3×3 dots for convenience of explanation.

FIG. 1 is an enlarged cross-sectional view centering the electron source of the FED panel. FIG. 1 is equivalent to a part of the cross section taken along line B-B′ of the FED panel of FIG. 17. In other words, one of the electron sources shown in FIG. 16B is enlarged and shown in FIG. 1.

As shown in FIG. 1, FIGS. 16A and 16B, and FIG. 17, in the FED panel of this embodiment, a cathode substrate 200 and an anode substrate 100 are arranged facing each other through an intermediary of a frame spacer(s) 116 and inner spacer(s) 40 to realize the FED panel.

As shown in FIG. 17, on the cathode substrate 200, the plurality of signal lines (data line) 11 and a plurality of scan lines are arranged intersecting each other at right angles on the insulating substrate 10 made of a glass etc.

A portion where the signal line 11 intersects a scan line 27 has a structure, as shown in FIG. 1, in which the signal line (lower electrode) 11, a first protective insulating layer 14, a second protective insulating layer (interlayer insulation film) 15, the scan line (upper bus electrode) 27, the connection auxiliary layer (connecting auxiliary electrode) 28, and the upper electrode 13 are laminated in this order on the substrate 10.

The signal line 11 is made up of Al, Al alloys, or the like. In this embodiment, it is made up of an Al—Nd alloy with 2 atomic weight % of Nd doped in Al.

The first protective insulating layer 14 serves to restrict the electron emission part and prevent an electric field from concentrating to the lower electrode edge. Here, the first protective insulating layer 14 is made up of Al oxide.

If the first protective insulating layer 14 has a pinhole, the second protective insulating layer 15 serves to embed the defect and maintain insulation between the signal line 11 and the scan line 27. SiN, SiON, etc. are used as the second protective insulating layer 15.

The scan line 27 is wiring for supplying electricity to the upper electrode 13 that is an electrode of the electron source (i.e., emitter) In the case of a large-sized FED panel, the scan line 27 consists of a layer of Ag, Cu, Ni, or the like that is given a thickness of a few micrometers to lower the resistance. The scan line 27 having a thick film thickens like this can be formed by the screen printing method using Ag paste.

The upper electrode 13 is, for example, a multilayer firm with a thickness of 1-10 nm in which Ir, Pt, and Au are laminated in this order by the sputtering method.

The connecting auxiliary layer 28 serves to contact both the scan line 27 and the upper electrode 13 and establish reliable conduction between the scan line 27 and the upper electrode 13. The connecting auxiliary layer 28 is formed using Al, Al alloys, or the like by the sputtering method etc.

As described above, the scan line 27 is formed by the screen printing method or the like in order to thicken the film. The surface of the scan line 27 formed by printing is usually uneven and coarse. On the other hand, the upper electrode 13 is a very thin film as described above. Therefore, if this upper electrode 13 is intended to be layered directly on the scan line 27, there may be a case where the upper electrode 13 is not layered uniformly, resulting in nonuniformity. In such a case, it will be impossible to achieve connection between the scan line 27 and the upper electrode 13. In line of this, the connecting auxiliary layer 28 that secures conduction between the scan line 27 and the upper electrode 13 is intended to be provided between them.

Such a connecting auxiliary layer 28 can be formed using Al, Al alloys, or the like by the sputtering method. The film thickness is usually in a rage of 200-1000 nm.

The electron source (cold cathode electron source) is provided at every position where the signal line 11 intersects the scan line 27. Each electron source serves as an image element. Broadly speaking, the cold cathode electron source is divided into the field emission type electron sources including: a Spindt-type electron source, a surface-conduction-type electron-emitter (surface-conduction electron-emitter), a carbon-nanotube-type electron source, etc.; and hot electron type electron sources including anMIM (Metal-Insulator-Metal) type electron source in which metal-insulator-metal are laminated and an MIS (Metal-Insulator-Semiconductor) type electron source in which metal-insulator-semiconductor electrode are laminated. Any electron source can be used for this invention. JP10-153979, JP2004-111053 described above, etc. disclose the MIM type electron sources.

In the FED panel of this embodiment, MIM type electron sources consisting of the lower electrode (signal line) 11, the insulating layer (electron acceleration layer) 12, and the upper electrode 13 are arranged.

An operation of the MIM type electron source will be explained briefly. When a drive voltage Vd is applied between the upper electrode 13 and the lower electrode 11 so that an electric field in the electron acceleration layer 12 is set to about 1-10 MV/cm, electrons near the Fermi level in the lower electrode 11 will penetrate a barrier by the tunnel phenomenon and will be injected to the electron acceleration layer 12 to become hot electrons. Although these hot electrons are scattered in the upper electrode 13 in the electron acceleration layer 12 and lose their energies, a part of hot electrons each having energy equal to or more than a work function φ of the upper electrode 13 are emitted into a vacuum 150.

The anode substrate 100 is made up of transparent glass plate etc. A black matrix 120, a phosphor 111, and an anode electrode 114 are formed on one of the surfaces of the anode substrate 100, and the formation plane is arranged to face a wire forming surface (surface having electrical wirings) of the cathode substrate 200.

An adhesive 115 of glass flit etc. is used to seal among the frame spacer 116, the cathode substrate 200, and the anode substrate 100 so that the pressure 150 inside the substrates can be maintained to about 10⁻⁵ Pa.

When the FED panel is in an operating status, as shown in FIG. 17, the end of the signal line 11 is being connected with the signal-line drive circuit 50 that is an external circuit. The end of the scan line is connected with the scan line drive circuit 60 that is an external circuit. An acceleration voltage 70 of about 3-6 kV is always applied to the anode electrode (metalback) 114. The FED panel operates as a display by, for example, a line-sequential driving method.

Explanation of Manufacturing Process

Next, a manufacturing process of the above-mentioned FED panel will be explained.

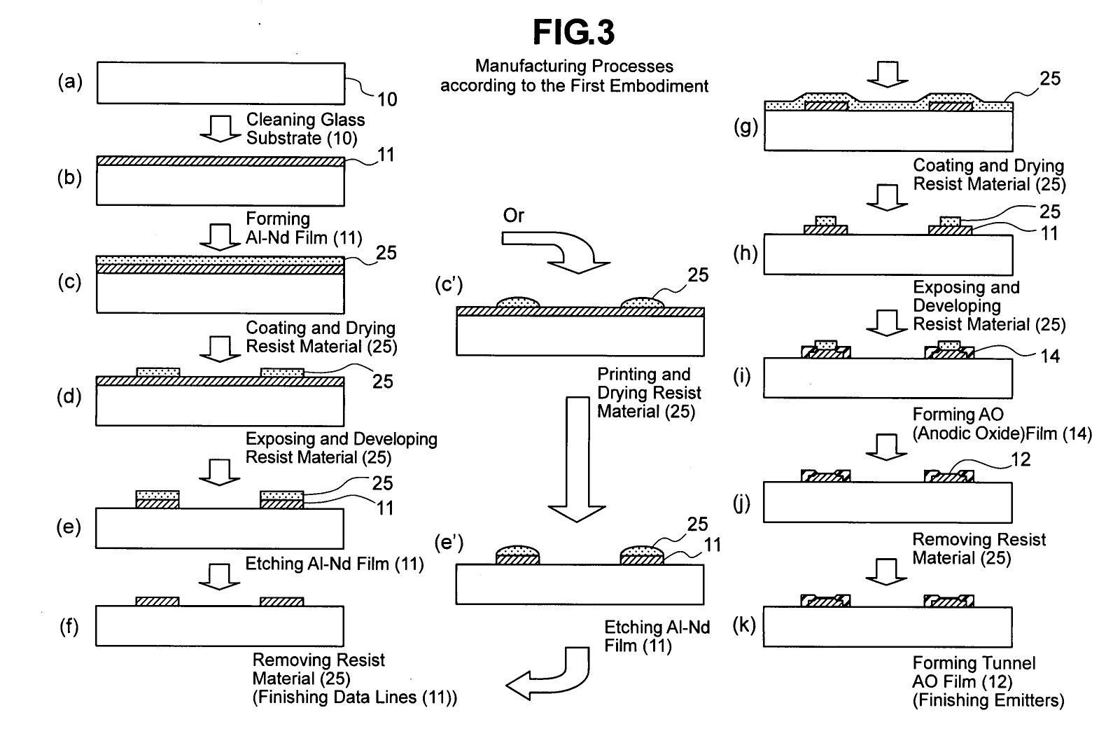

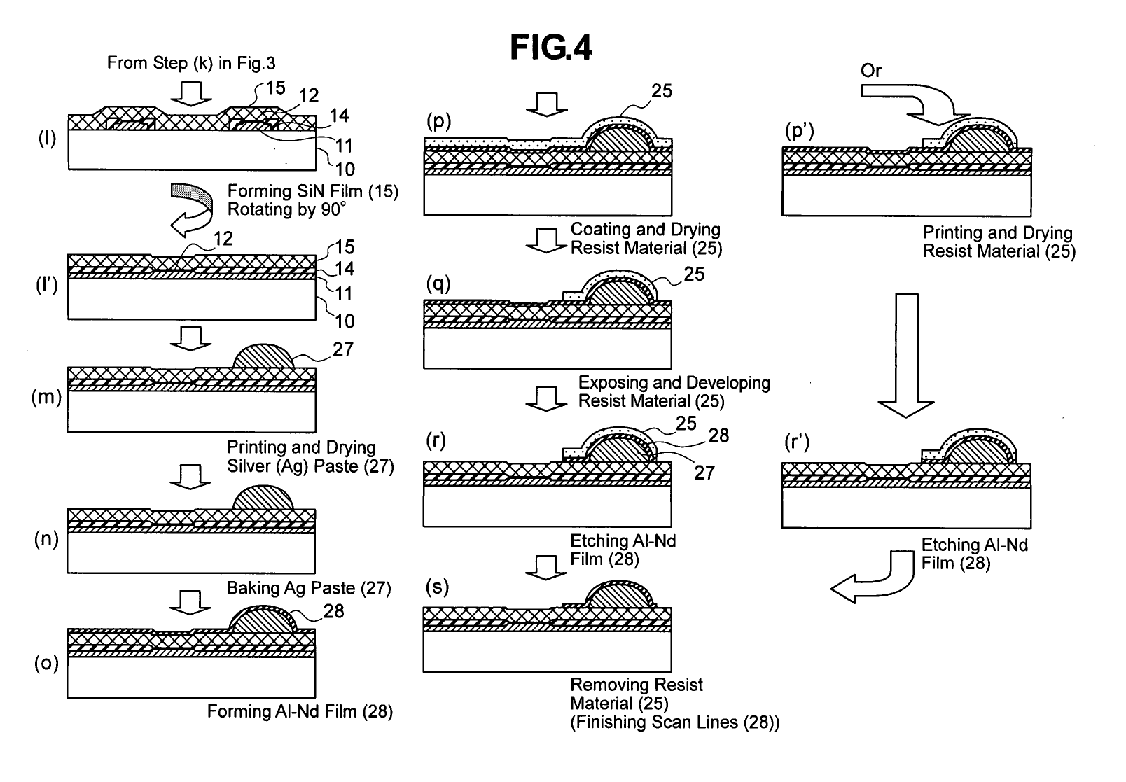

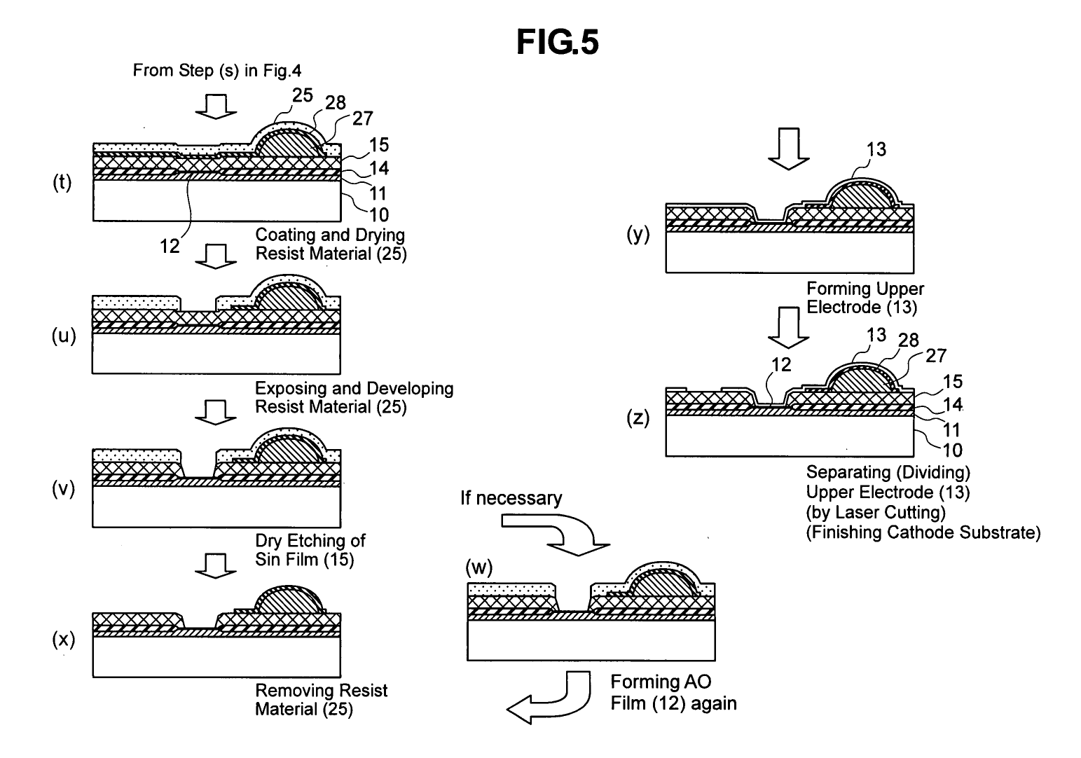

FIGS. 3-5 are diagrams showing the manufacturing process of the cathode substrate. What is shown in Steps (a) to (k) of FIG. 3 and Step (1) of FIG. 4 is a part of a cross section taken along line A-A, ′ and what is shown in Steps (1′) to (s) of FIG. 4 and Steps (t) to (s) of FIG. 5 is a part of a cross sections taken along line B-B.′

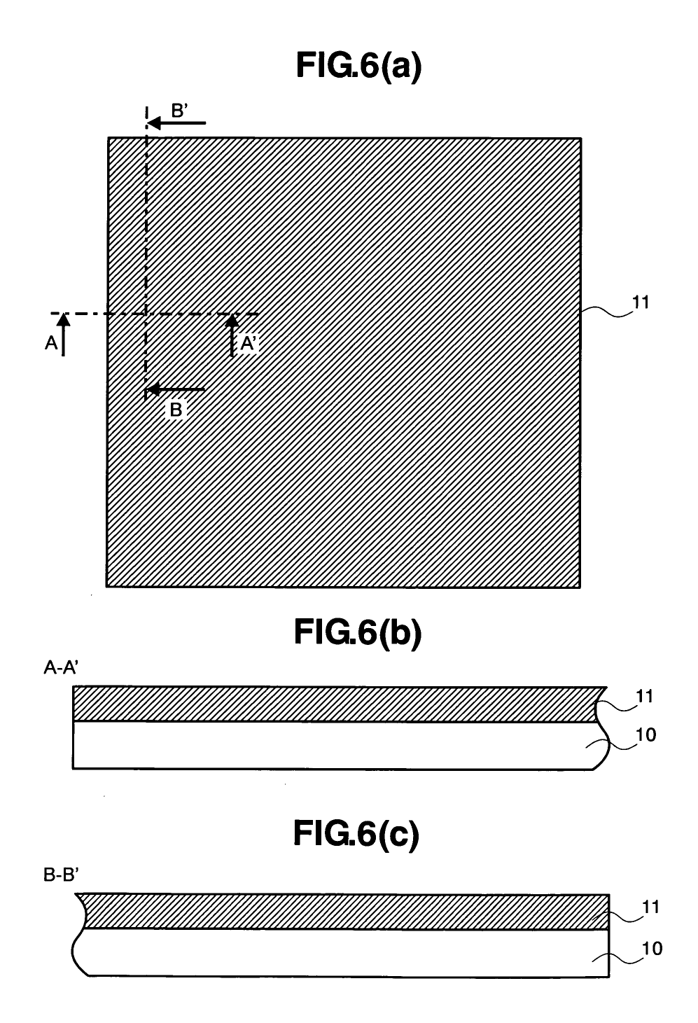

Each of FIGS. 6A, 7A, 8A, 9A, 10A, 11A, 12A, 13A, and 14A shows a plan view of a substrate at each stage corresponding to the above-mentioned manufacturing step. Each of FIGS. 6B, 7B, 8B, 9B, 10B, 11B, 12B, 13B, and 14B shows a cross section taken along line A-A′ that corresponds to the each of the above views, and each of FIGS. 6C, 7C, 8C, 9C, 10C, 11C, 12C, 13C, and 14C shows a cross section taken along line B-B′ that corresponds to the each of the above views.

First, the insulating substrate 10, such as of a glass etc., is cleaned (Step (a) of FIG. 3).

Next, the metal film 11 for a lower electrode is deposited on the substrate 10 (see Step (b) of FIG. 3 and FIGS. 6A-6C). As a material of the lower electrode, Al, Al alloys, etc. can be used. If Al or an Al alloy is used, an excellent-quality insulating film can be formed by subsequent anodic oxidation. In this embodiment, an Al—Nd alloy with 2 atomic-weight % of Nd doped in Al was used as the metal film 11. In order to form this film, for example, the sputtering method is used. This thickness is about 300 nm.

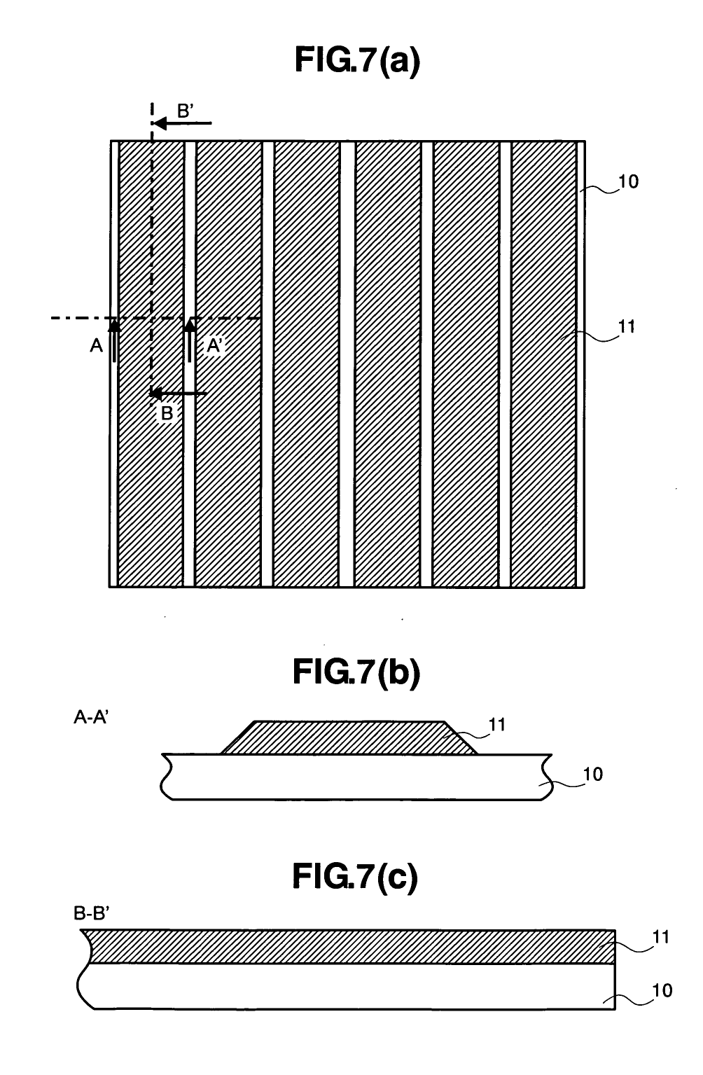

After the film formation, the lower electrode 11 in the form of stripes is formed by a photolithography process and an etching process (see Steps (c) to (f) of FIG. 3 and FIGS. 7A-7C corresponding to Step (f)). The metal film 11 is etched using a pattern (see Step (d) or (c′) of FIG. 3) of a resist material 25 formed on its upper surface (see Step (e) or (e′) of FIG. 3) to form a plurality of signal lines (data lines) that are extended in a first direction (a transverse direction of FIG. 7A) and are in aligned relation to each other (juxtaposed) in a second direction (a longitudinal direction of FIG. 7A) intersecting the first direction in the principal surface of the substrate 10. Note that in this embodiment, the lower electrode 11 serves as the signal line (data line). The etching process of the metal film 11 is conducted, for example, by wet etching that uses a mixed aqueous solution of phosphoric acid, acetic acid, and nitric acid.

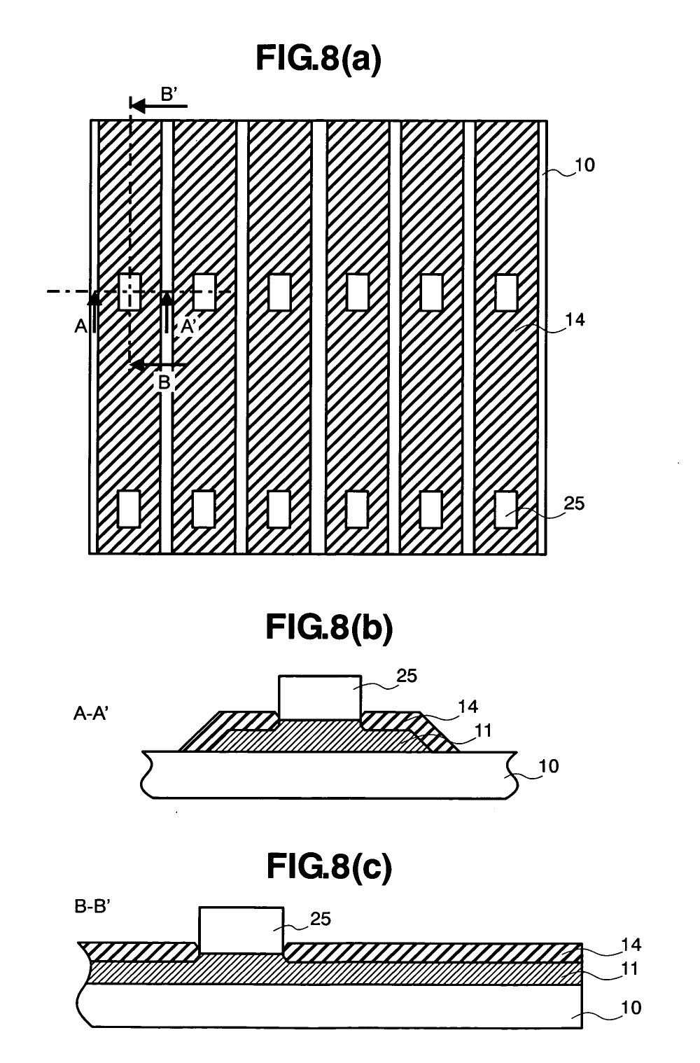

Next, the first protective insulating layer 14 is formed for each of the plurality of signal lines (data line) 11 (see Steps (g) to (i) of FIG. 3 and FIGS. 8A-8C corresponding to Step (i)). The first protective insulating layer 14 serves to restrict the electron emission part (for example, an area where an MIM type electron source on the principal surface of the signal line 11 is formed) and prevent an electric field from concentrating in an edge of the lower electrode.

In this process, first, a part that will become an electron emission part on the lower electrode 11 is masked with the resist film 25, and other part is selectively subjected to anodic oxidation to form the first protective insulating layer 14. In order to conduct anodic oxidation (formation of the protective insulating layer 14 composed of its oxide) on the surface of the lower electrode 11, an area that should be anodized (on which the protective insulating layer 14 should be formed) on the lower electrode 11 is soaked in an electrolytic solution and a voltage is applied between another electrode soaked in this electrolytic solution and the area in concern. This voltage is called a formation voltage. For example, if the formation voltage is set to 100 V, the first protective insulating layer 14 about 136 nm thick will be formed on the surface of the lower electrode (or a data line constituting this electrode) 11. In this embodiment, since a part of a conducting layer formed as the so-called signal line (data line) 11 is used as the lower electrode 11 of the electron source, the reference numeral 11 may designate the signal line (data line) itself or may designate the lower electrode formed in a part thereof. So, attention must be paid on this.

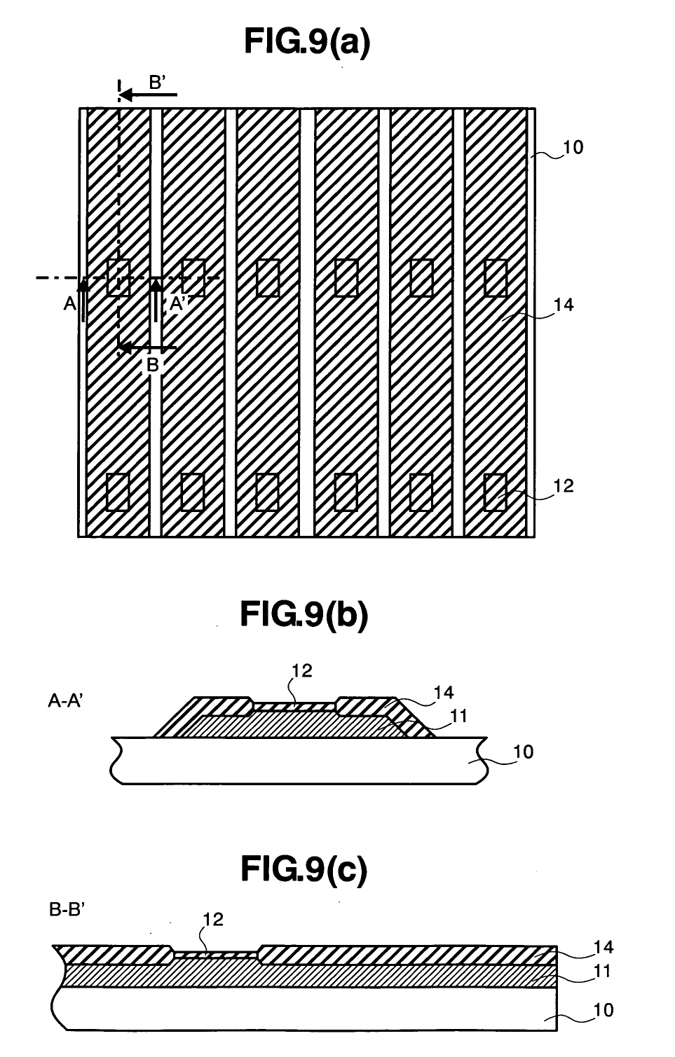

Next, the electron acceleration layer 12 is formed in a part that will become the electron emission part (for example, an area exposed by an opening of the first protective insulating layer 14) on the lower electrode 11 (see Steps (j) to (k) of FIG. 3 and FIG. 9A-9C corresponding to Step (k)). That is, the resist film 25 is removed (see Step (j) of FIG. 3) and a remaining surface of the lower electrode 11 is anodized (an area on which the first protective insulating layer 14 will not be formed) to form the electron acceleration layer 12. In this embodiment, the electron acceleration layer 12 is also formed by the same technique as that of the first protective insulating layer 14, but its thickness is thinner than the first protective insulating layer 14. This feature is important to an electron source having a multilayer structure created by inserting the low-conductivity (insulating) electron acceleration layer 12 between the lower electrode 11 and the upper electrode 13 that will be described later. For example, if the formation voltage is set to 6 V, the electron acceleration layer 12 about 10 nm thick is formed on the lower electrode 11.

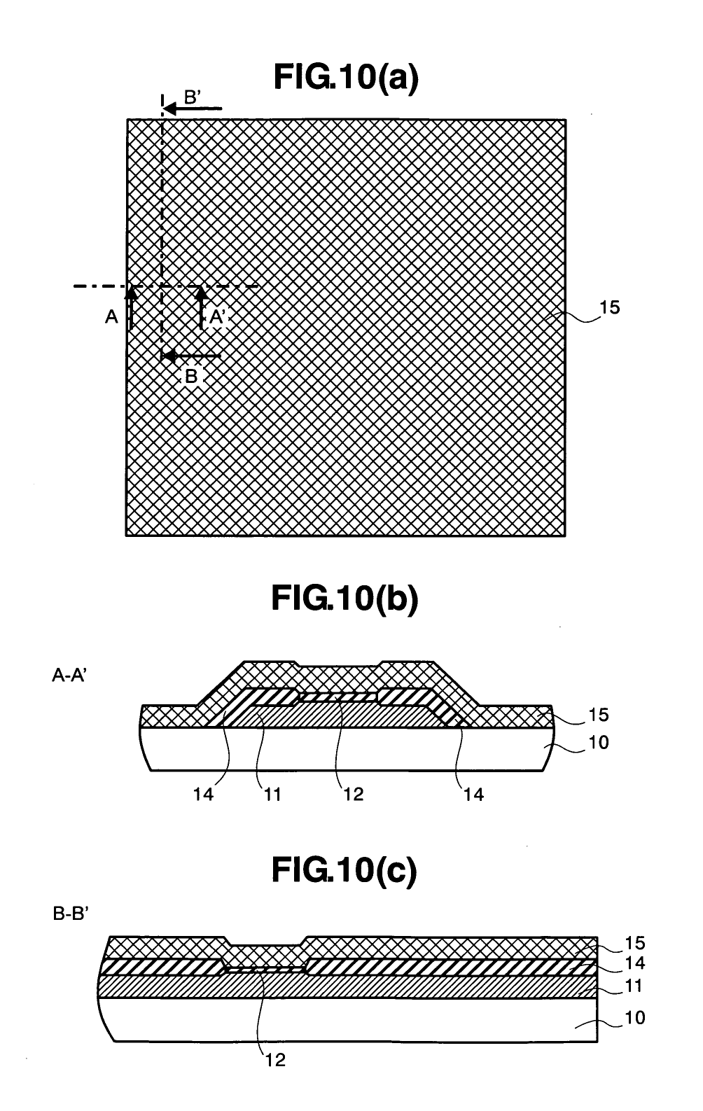

Next, the second protective insulating layer 15 is formed by deposition using the sputtering method etc. (see Steps (1) to (1′) of FIG. 4 and FIGS. 10A-10C corresponding to them). Cross sections shown in Step (1) and in Step (1′) are for a structure at the same stage in the manufacturing process of this embodiment, each being drawn from a point of view different from the other by 90° (rotated by 90° in the principal surface of the substrate). If the first protective insulating layer 14 formed by anodic oxidation has a pinhole, the second protective insulating layer 15 serves to embed the defect and maintain insulation between the lower electrode 11 and the upper electrode (scan-line) 27. SiN etc. is used as the second protective insulating layer 15. The thickness was chosen 40 nm.

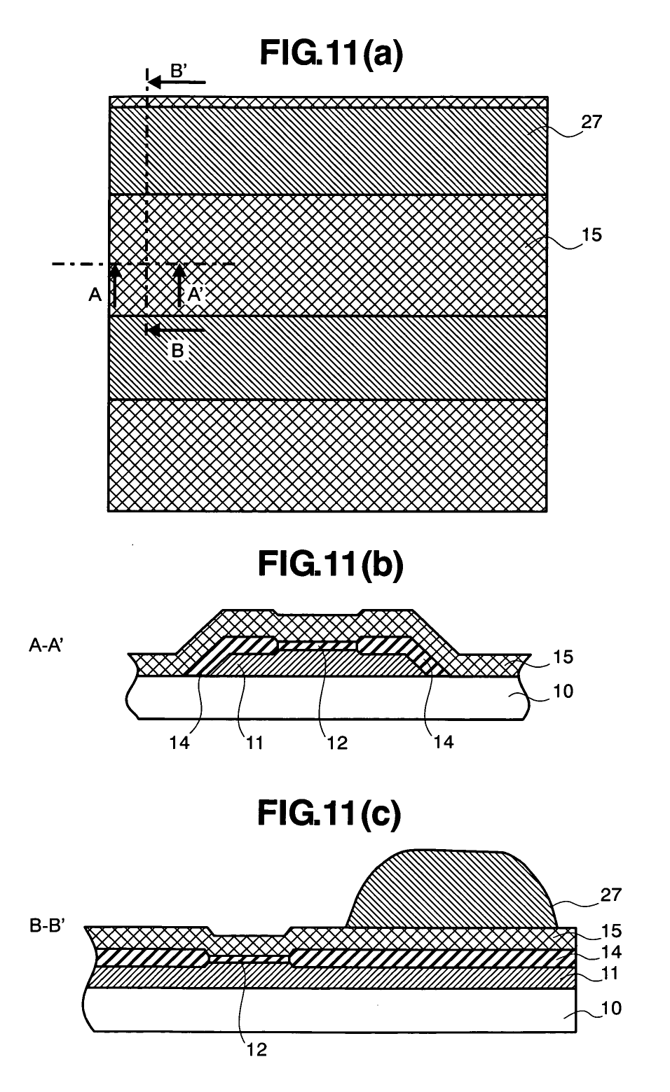

Next, the upper bus electrode 27 that will become a power supply line of the upper electrode 13 is formed (see Steps (m) to (n) of FIG. 4 and FIGS. 11A-11C corresponding to Step (n))

Since the upper bus electrode 27 functions as a scan line, its thickness is thickened in order to reduce its resistance. Any particular restriction is not imposed on a method of forming a thick film like this. For example, it can be formed by the screen printing method using Ag paste etc. (Step (m)).

It is preferable to use Ag paste that can be baked at a temperature equal to or lower than a hear-resistant temperature (e.g., allowable temperature limit) of the electron source (Step (n)). For example, in the case where an MIM electron source is provided, since heat resistance property (e.g., thermostability) of the MIM electron source is about 430° C., it is preferable to use Ag paste that can be baked at 430° C. or less.

The Ag wiring is so formed that its thickness usually falls in a range of 5-30 μm, and that its line width usually falls in a range of 100-300 μm.

The thickness may be thickened by repeating screen printing for a plurality of times.

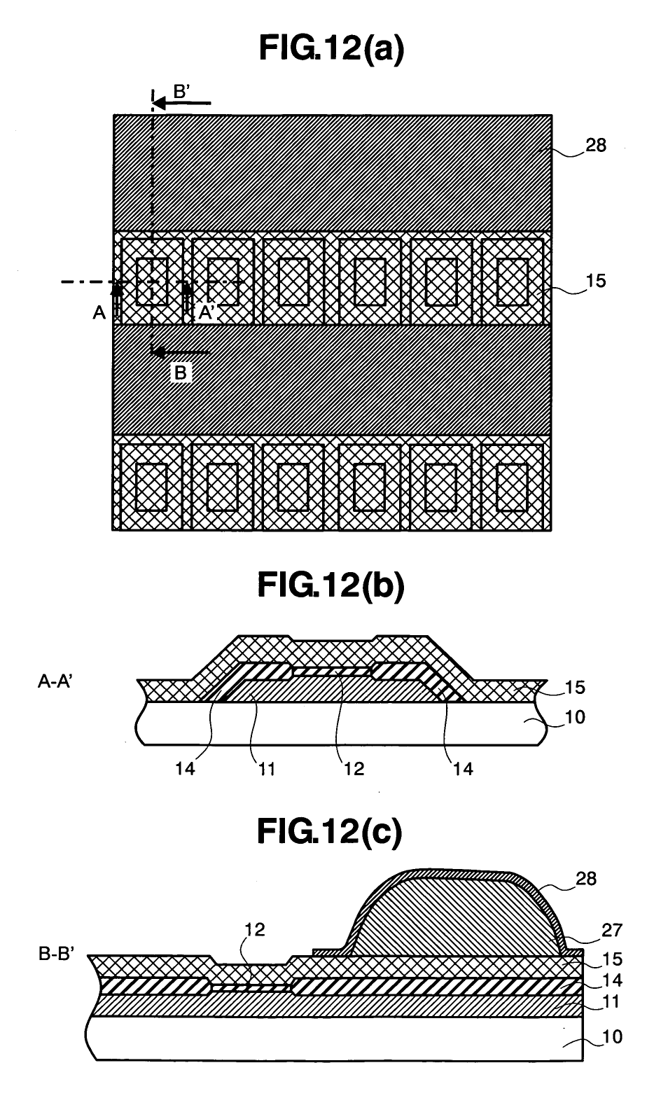

Next, the connecting auxiliary layer 28 that is a layer for heightening the connection reliability (see Steps (o) to (s) of FIG. 4 and FIGS. 12A-12C corresponding to Step (s)). After forming a film of the connecting auxiliary layer 28 by the sputtering film forming method (Step (o)), it is processed by a photoetching process (Steps (q) to (r)) so that wirings remain on the upper bus electrode 27 (Step (s)). Alternatively, by printing and drying the resist material 25 on the upper surface of the material layer that will become the connecting auxiliary layer 28 (Step (p′)), the above-mentioned material layer may be etched using a pattern of the resist material 25 without undergoing the photoetching process.

As a material of the connecting auxiliary layer 28, an Al—Nd alloy can be used. As other choices, Al, Cu, Cr, Cr alloys, etc. are usable. The thickness of the connecting auxiliary layer 28 is 200-1000 nm.

In addition, as an etchant for the Al—Nd alloy etc., a mixed aqueous solution of phosphoric acid, acetic acid, and nitric acid or the like can be used to Al—Nd alloys etc.

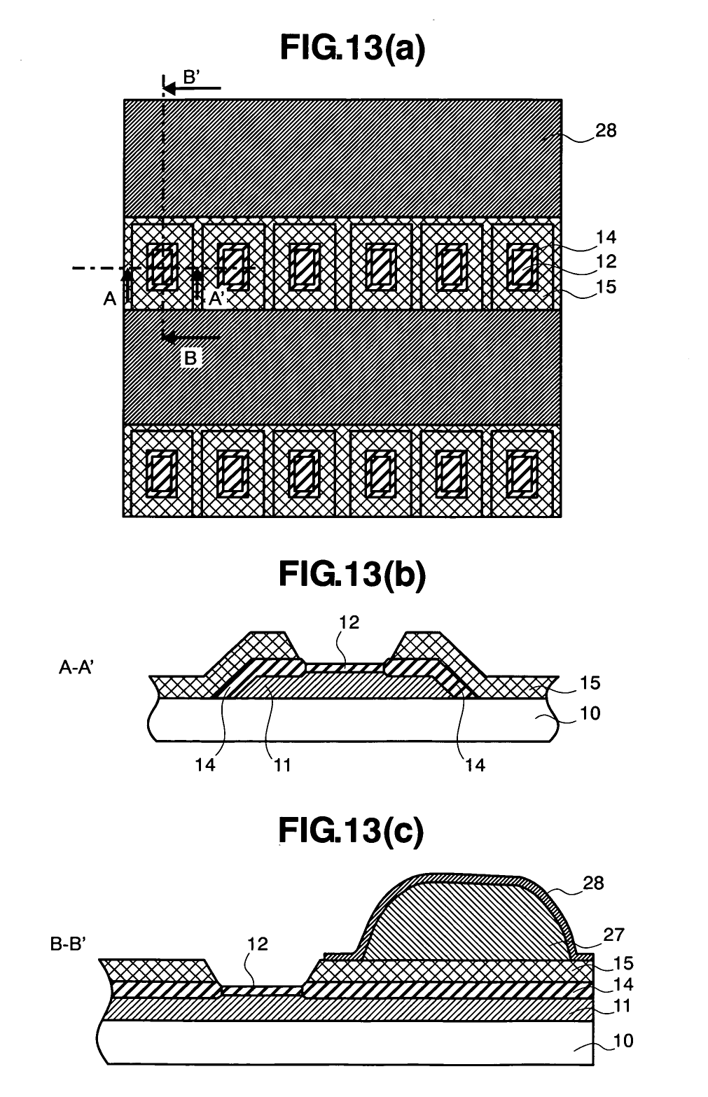

Next, SiN etc. of the second protective insulating layer 15 is dry etched so that the opening is formed for the electron emission part (an upper part of the electron acceleration layer 12) (see Steps (t)to (x) of FIG. 5 and FIGS. 13A-13C corresponding to Step (x)).

Note that, if needed, the electron acceleration layer 12 is anodized again to restore damage of the electron acceleration layer 12, formed beforehand (Step (w) of FIG. 5).

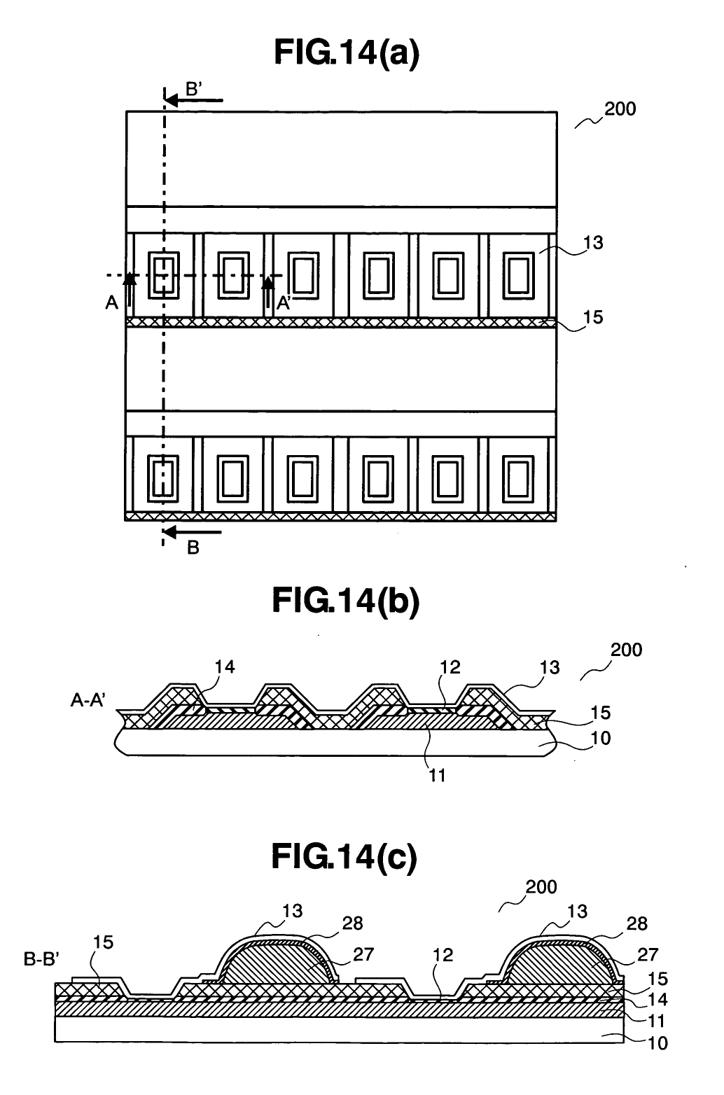

Next, film formation and film processing of the upper electrode 13 are conducted (see Steps (y) to (z) of FIG. 5 and FIGS. 14A-14C corresponding to Step (z)).

For the film formation method, for example, the sputter film formation method is used (Step (y)). As the upper electrode 13, for example, a multilayer film made by laminating Ir, Pt, and Au in this order can be used. The thickness is 1-10 nm. In this embodiment, it is chosen 3 nm. Then, the upper electrode 13 is separated for each scan line by a laser (Step (z)) (laser cutting). An opening of the upper electrode 13 (or conducting film to be processed to it) shown in a cross-sectional view of Step (z) of FIG. 5 and in FIG. 14C constitutes a “groove” that exposes the second protective insulating layer (SiN film) 15 and extends in an extension direction (transverse direction) of the upper bus electrode 27 in FIG. 14A. In other words, the plurality of upper electrodes 13 provided for the respective scan lines (the upper bus electrode 27) are aligned in the extension direction of the data line (the lower electrode 11), and each of the upper electrodes 13 applies a voltage to each of the electron sources (an area where the electron acceleration layer 12 is formed) being provided for one group (pixel sequence) of pixels operated by one of the scan lines corresponding to this. The deposited thin upper electrode 13 partially constitutes a structure to which the upper bus electrode 27 supplies electric power through the connecting auxiliary layer 28. It is preferable that the connecting auxiliary layer 28 is extended toward the electron source that this supplies electric power (i.e., that applies a voltage) from the upper surface of the upper bus electrode 27. For example, preferably the connecting auxiliary layer 28 is formed so as to protrude from the upper surface of the upper bus electrode 27 to a principal surface of its underlayer (the second protective insulating layer 15, in FIG. 14C). The connecting auxiliary layer 28 and the upper electrode 13 are connected together on the principal surface of the underlayer that is smoother (less inclined and with a smaller curvature) than the upper surface of the upper electrode 13, whereby electric resistance reaching to the electron source (pixel) from the upper bus electrode 27 is further held down.

According to these steps, the substrate (cathode substrate) 200 comprising the substrate 10 and the electron sources (display elements) formed thereon is manufactured.

Next, a process of making an FED panel (display panel) using the cathode substrate 200 manufactured as described above will be explained.

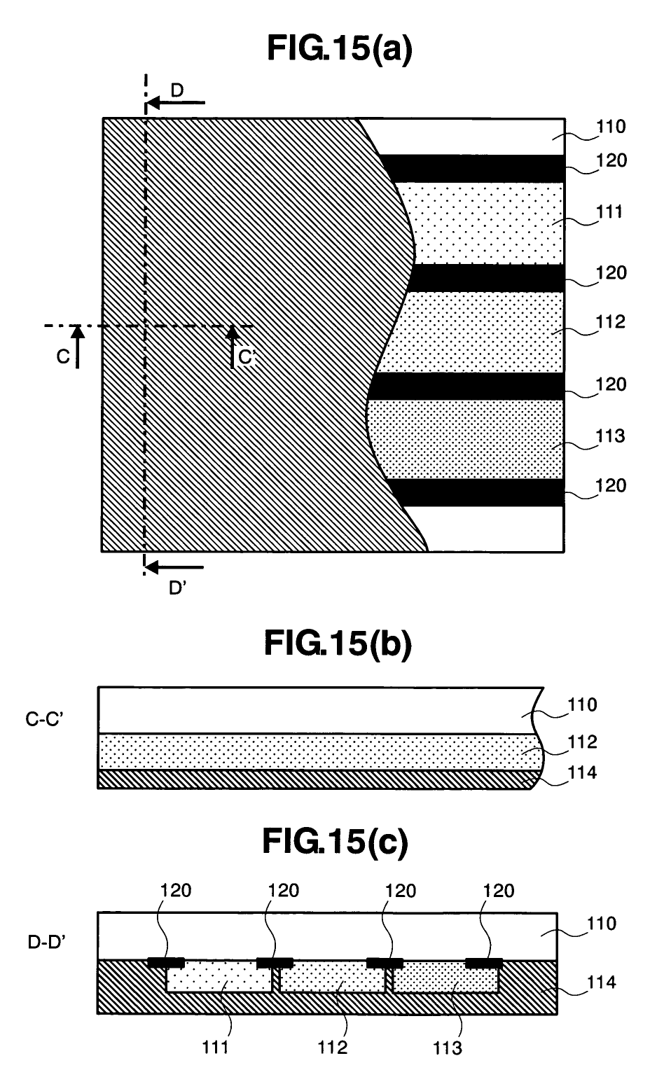

First, the anode substrate (a display side substrate) 100 is made. FIG. 15A is a plan view of the anode substrate 100, FIG. 15B is a cross-sectional view taken along line C-C, ′ and FIG. 15C is a cross-sectional view taken along line D-D.′

A transparent glass or the like is used for a face plate 110. First, the black matrix 120 for enhancing contrast of a display is formed on the face plate 110. Specifically, a solution that is a mixture PVA (polyvinyl alcohol) and sodium dichromate is coated on the face plate 110, and portions other than other portions where the black matrix 120 is intended to be formed are subjected to ultraviolet light rays to effect sensitization. Then, non-sensitized portions are removed, and coated with a solution in which graphite powder is solved. Then, the graphite layer is patterned by a PVA liftoff technique.

Next, the red phosphor 111 is formed. Specifically, an aqueous solution in which phosphor particle, PVA (polyvinyl alcohol), and ammonium dichromate are mixed is coated on the face plate 110, and subsequently portions in which phosphor is intended to be formed is irradiated with ultra violet-rays to effect sensitization. Subsequently, non-sensitized portions are removed with flowing water. In this way, the red phosphor 111 is patterned. The patterning is such as to provide a pattern in the form of stripes as shown in FIG. 15. Similarly, a green phosphor 112 and a blue phosphor 113 are formed. For phosphors, it is recommended to use, for example, Y₂O₂S: Eu (P22-R) for red, ZnS: Cu, Al (P22-G) for green, and ZnS: Ag, Cl (P22-B) for blue. No that, in this embodiment, since the distance between the face plate 110 and the substrate 10 is as long as about 1-3 mm, the acceleration voltage applied to the metal back 114 can be a high voltage of 3-6 kV. Therefore, a phosphor for cathode-ray tubes (CRT) can be used for phosphors.

For patterning of a phosphor, a dot pattern can be directly formed using the screen printing method. In this case, a paste prepared by mixing phosphor particles with a binder, such as ethyl cellulose, and a solvent, such as BCA (Butyl Carbitol Acetate) is used. By repeating screen printing and drying of pastes of R (red), G (green), and B (blue), three times, phosphor patterns are formed in the similar forms.

Next, the phosphors are subjected to filming, and then Al is vapor-deposited on the whole face plate 110 to a thickness, of about 75 nm, which will be used as the metal back 114. This metal back 114 works as an accelerating electrode. After this, the face plate 110 is heated to about 400° C. in the atmosphere, and organic substances such as the filming film and PVA are thermally decomposed.

As described above, the anode substrate 100 is finished.

Next, the anode substrate 100 and the cathode substrate 200 thus manufactured are cemented together. FIG. 16A is a cross-sectional view taken along line A-A′ of an FED panel shown in FIG. 17 made by cementing the anode substrate 100 and the cathode substrate 200; FIG. 16B is a cross-sectional view thereof taken along line B-B.′ As shown in the both views, the anode substrate 100 and the cathode substrate 200 are sealed at respective peripheries using flit glass 115 through an intermediary of the frame spacer 116.

Inner spacers are arranged between the face plate 110 and the substrate 10 and their heights are so adjusted that the distance therebetween may be set to about 1-3 mm. Although in this view, the inner spacers 40 are set standing for all the dots that emit lights of R (red), G (green), and B (blue) for purposes of illustration, the inner spacers 40 may be decreased in number (density) actually as long as the panel can endure required mechanical strength. It may be sufficient to arrange the inner spacers 40 standing in intervals of, for example, about 1 cm.

The sealed panel is evacuated to a vacuum of about 10⁻⁵ Pa, and sealed airtightly. After the sealing, a getter is activated and the vacuum inside the panel is maintained. For example, in the case of a getter material whose principal component is Ba, a getter film can be formed by high frequency induction heating etc. Alternatively, a non-evaporation type getter whose principal component is Zr may be used.

The FED panel manufactured in this way is connected with the drive circuits 50, 60, as shown in FIG. 17, and operates as a display.

The FED panel of this embodiment and its manufacturing process were explained above.

According to this embodiment, the FED panel that has the scan lines whose thickness is sufficiently thick and whose resistance is thereby lowered. Therefore, this is an FED panel in which voltage drop can be suppressed and brightness unevenness is reduced.

Moreover, even in the case where the scan line having a coarse surface is formed by the printing method etc. in order to form the scan lines in a thick film, since the connecting auxiliary layer for establishing conduction between the scan line and the upper electrode is provided between them, the structure enables the scan line to properly supply electric power to the upper electrode.

### SECOND EMBODIMENT

An FED panel of a second embodiment has a configuration similar to the FED panel of the first embodiment described above. Therefore, explanations for the configuration and manufacturing process common to each other will be omitted in some respects.

The FED panel of the second embodiment differs from the Fed panel of the first embodiment in the structure of the cathode substrate 200.

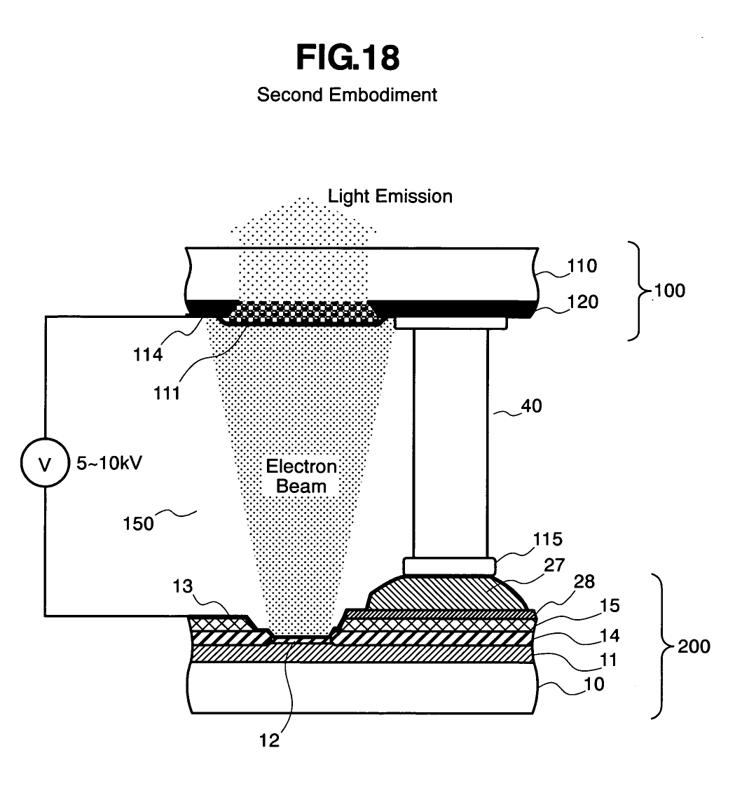

FIG. 18 is an enlarged cross-sectional view of the FED panel of the second embodiment (cross-sectional view taken along a direction corresponding to line B-B′ described above in the FIG. 16B in reference to FIG. 1).

As shown in FIG. 18, in a portion where the signal line 11 intersects the scan line 27, the FED panel has a multilayer structure in which the signal line (lower electrode) 11, the first protective insulating layer 14, the second protective insulating layer 15, the connecting auxiliary layer 28, the scan line (upper bus electrode) 27, and the upper electrode 13 are laminated in this order on the substrate 10. The signal line 11 is sometimes called a data line.

The connecting auxiliary layer 28 connects both the upper electrode 13 and the scan line 27. Like the connecting auxiliary layer 28 of the first embodiment described above, the connecting auxiliary layer 28 is provided in order to establish reliable conduction between the upper electrode 13 and the scan line 27. This embodiment has a structure in which the connecting auxiliary layer 28 is formed on the principal surface of the second protective-insulating layer (formed with a dielectric such as SiN) that will become an underlayer of the scan line 27 and the scan line 27 is formed on the upper surface of the connecting auxiliary layer 28, which differs from a counterpart of the first embodiment. However, this embodiment and the first embodiment are common with the structure in which the connecting auxiliary layer 28 projects from the scan line 27 toward the electron source (in an area in which the electron acceleration layer 12 is formed).

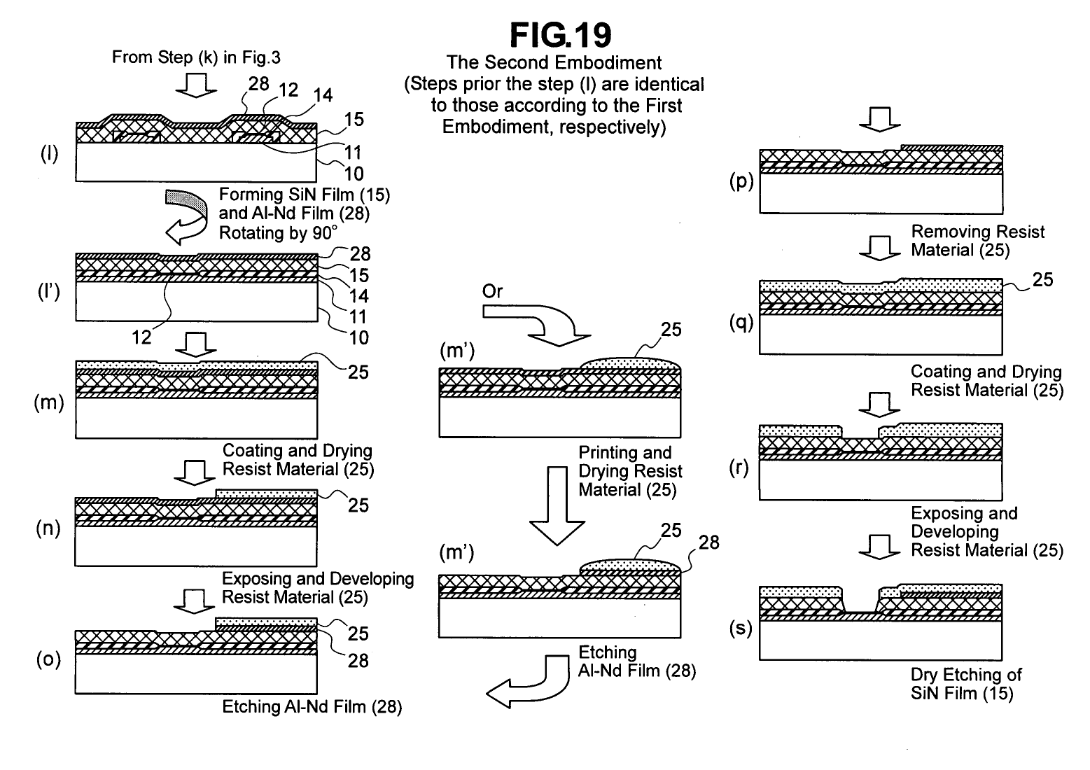

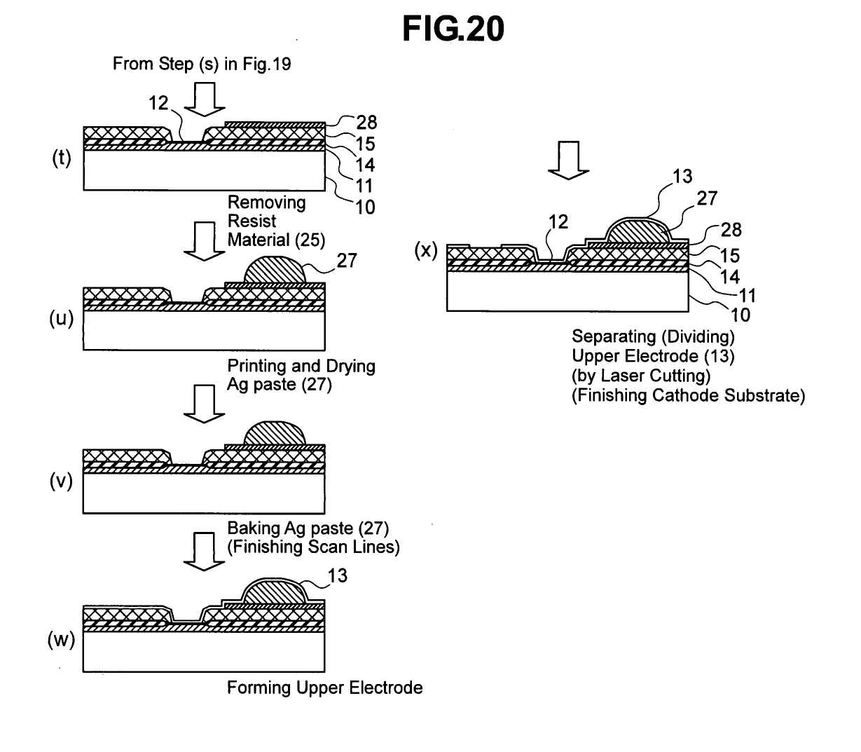

A manufacturing process of the cathode substrate 200 like this will be explained using FIGS. 19 and 20. The steps from the start to a halfway point are the same as Steps (a) to (k) shown in FIG. 3.

After Step (k) of FIG. 3, the second protective insulating layer 15 and the connecting auxiliary layer 28 are deposited by the sputtering method etc. in this order (Step (1) and Step (1′) of FIG. 19). Incidentally, cross sections shown in Step (1) and in Step (1′) are for a structure at the same stage in the manufacturing process of this embodiment, each being drawn from a point of view different from the other by 90° (rotated by 90° in the principal surface of the substrate 10).

If the first protective insulating layer 14 formed by anodic oxidation has a pinhole, the second protective insulating layer 15 serves to embed the defect and maintain insulation between the lower electrode 11 and the upper bus electrode (scan line) 27. SiN etc. is used for the second protective insulating layer 15. Thickness is chosen 200 nm.

As a material of the connecting auxiliary layer 28, Al—Nd alloys can be used. In addition to this, Al, Cu, Cr, Cr alloys, etc. are usable. The thickness of the connecting auxiliary layer 28 is 200-1000 nm.

Next, by the photo etching process, the connecting auxiliary layer 28 is formed (Steps (m) to (p) of FIG. 19) into the form of the same stripes intersecting (for example, crossed at right angles) the signal lines 11 as the shape of the scan lines 27 that will be formed in a latter step. In Step (o) or Step (o′), as an etchant for etching a conducting film that will become the connecting auxiliary layer 28 to a shape of the connecting auxiliary layer 28, a mixed aqueous solution of phosphoric acid, acetic acid, and nitric acid etc. can be used for Al—Nd alloys etc.

Next, the second protective insulating layer 15 made up of SiN etc. is dry-etched to give the opening in the electron emission part (an upper part of the electron acceleration layer 12) (Steps (p) to (s) of FIG. 19 and Step (t) of FIG. 20).

If needed, the electron acceleration layer 12 is anodized again, so that damages produced in the electron acceleration layer 12 already formed in Step (k) shown in FIG. 3 are restored. It is recommended to conduct this processing by soaking the substrate 10 in an electrolytic solution at a stage when Step (t) of FIG. 20 has been ended.

Next, the upper bus electrode 27 that will become a power supply line of the upper electrode 13 is formed (Steps (u) to (v) of FIG. 20).

In Step (u), attention must be paid so that the connecting auxiliary layer 28 may not be completely covered with the upper bus electrode 27. This is done because the connecting auxiliary layer 28 is made contact able with the upper electrode 13 that will be formed in a later step.

Since the upper bus electrode 27 serves to be a scan line, its thickness is thickened in order to decrease the resistance. For example, a maximum thickness of the upper bus electrode 27 is made thicker than the thickness of the connecting auxiliary layer 28, preferably being twice the thickness of the connecting auxiliary layer 28 or more. Although no limit is particular placed in the method of forming a thick film like this, the film can be formed, for example, by the screen printing method using Ag paste etc.

It is preferable to use Ag paste that can be baked at a heat-resistant temperature of the electron source or less (Step (v)). For example, in the case where the MIM electron source is provided, since heat resistance property of the MIM electron source is about 430° C., it is preferable to use Ag paste that can be baked at 430° C. or less.

The Ag wiring (the upper bus electrode 27) shall be so formed that its thickness may usually fall in a range of 5-30 μm. Moreover, it (the Ag wiring) shall be so formed that the line width usually falls in a range of 100-300 μm.

Alternatively, the thickness of the Ag wiring (the upper bus electrode 27) may be thickened by repeating the screen printing for a plurality of times.

Next, film formation and film processing of the upper electrode 13 are conducted (Steps (w) to (x) of FIG. 20).

For film deposition of a conducting film formed on the upper electrode 13, for example, the sputtering film forming method is used (Step (w)). As the upper electrode 13, a multilayer film made by laminating Ir, Pt, and Au in this order can be used. The thickness is 1-10 nm. In this embodiment, it was chosen 3 nm. Then, a laser is used to separate the upper electrode 13 for each scan line. This gives a structure in which the deposited thin upper electrode 13 is supplied electric power from the upper bus electrode 27. In this structure, even if contact between the upper electrode 13 and the upper bus electrode 27 is not sufficient, the upper electrode is properly supplied electric power from the upper bus electrode through the connecting auxiliary layer 28.

The cathode substrate 200 thus manufactured is combined with the anode substrate 100 like the first embodiment described above, and sealed. Then, the FED panel is finished.

The FED panel of the second embodiment and its manufacturing process were explained above.

According to this embodiment, there is provided the FED panel that has the scan lines whose thickness is sufficiently thick and whose resistance is thereby lowered. Therefore, this is an FED panel such that a voltage drop can be suppressed and its brightness unevenness is reduced.

Moreover, even in the-case where the scan line having a coarse surface is formed by the printing method etc. in order to form the scan lines in a thick film, since the connecting auxiliary layer for establishing conduction between the scan line and the upper electrode is provided between them, the structure enables the scan line to properly supply electric power to the upper electrode.

### THIRD EMBODIMENT

An FED panel of a third embodiment has a configuration similar to the FED panel of the first embodiment described above. Therefore, explanations for the configuration and manufacturing process common to the first embodiment will be omitted in some respects in the following descriptions.

The FED panel of the third embodiment differs from the FED panel of the first embodiment in the structure of the cathode substrate 200.

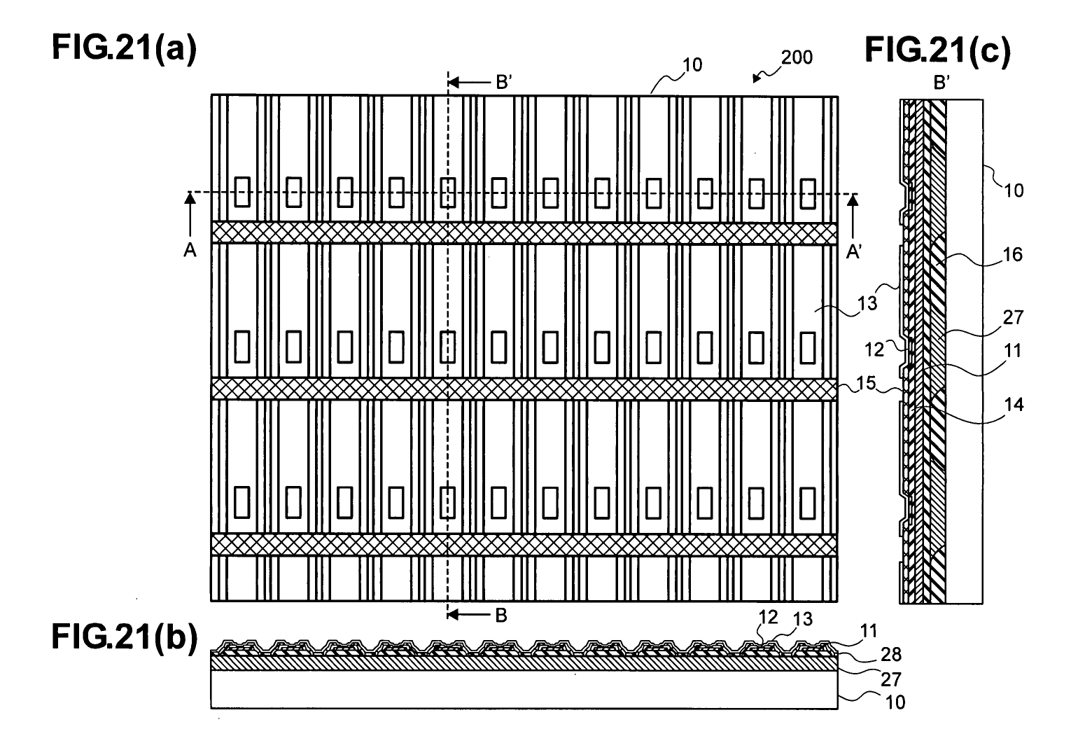

FIG. 21A is a plan view of the cathode substrate 200 of the third embodiment. FIG. 21B is across-sectional view taken along line A-A′ of FIG. 21A, and FIG. 21C is a cross-sectional view taken along line B-B′ of FIG. 21A.

As shown in FIGS. 21B and 21C, in the cathode substrate 200 of this embodiment, the scan line 27 for supplying electric power to the upper electrode 13 exists in a layer~lower than the signal line 11 (near the substrate 10).

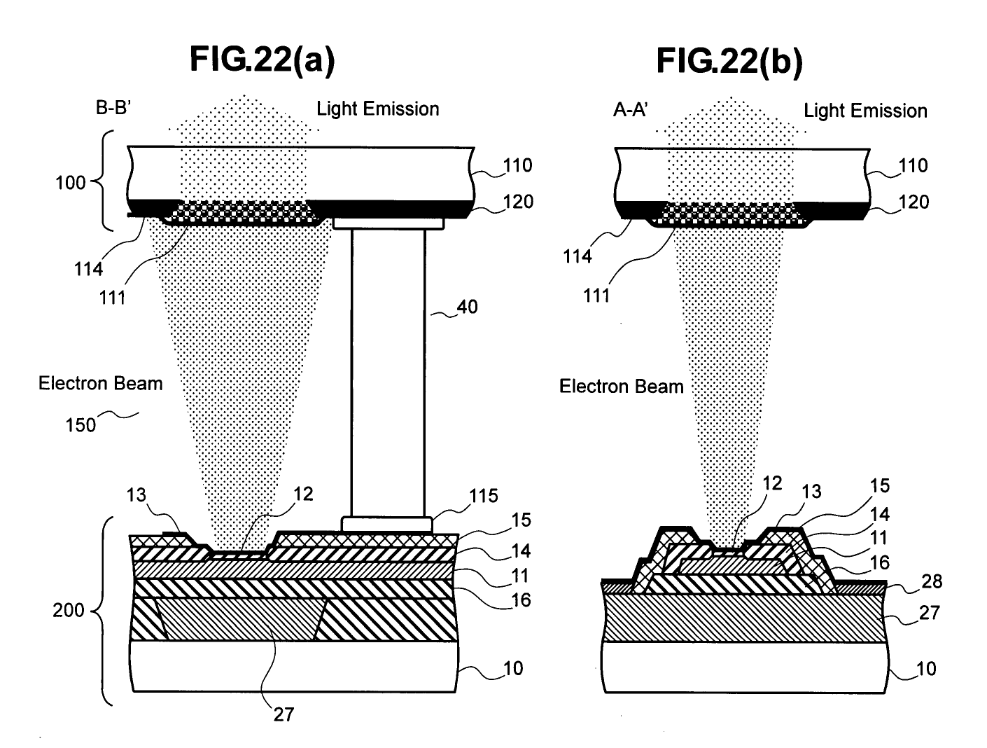

FIGS. 22A and 22B are enlarged cross-sectional views of the portion where the signal line 11 intersects the scan line 27 of the display (the FED panel) of this embodiment that uses the cathode substrate 200 shown in FIG. 21A-21C. In other words, a cross section of one electron source (an area where the electron acceleration layer 12 is formed) of the display is enlarged and shown in FIGS. 22A and 22B. FIG. 22A shows a part of cross section of the FED panel cut by line B-B′ of FIG. 21A, and FIG. 22B shows a part of cross section of the FED panel cut by line B-B′ of FIG. 21A, respectively.

As shown in FIGS. 22A and 22B, respectively, a part of the cathode substrate 200 where the electron source is placed has a multilayer structure in which the scan line 27, the insulating layer 16, the signal line 11, the electron acceleration layer 12, and the upper electrode 13 are laminated in this order on the substrate 10. The insulating layer 16 is formed, for example, by baking dielectrics glass paste.

As shown in FIG. 22B, the connecting auxiliary layer 28 is provided between the scan line 27 and the upper electrode 13. In other words, there exist a structure in which the scan line 27, the connecting auxiliary layer 28, and the upper electrode 13 are laminated in this order.

Suppose the upper electrode 13 that is an extremely thin film is layered directly on the scan line 27 without providing the connecting auxiliary layer 28, when the surface of the scan line 27 is coarse, it may be not laminated uniformly resulting in unevenness. In such a case, a failure arises in the conduction between the scan line 27 and the upper electrode 13. In this embodiment, since the connecting auxiliary layer 28 is provided, it establishes secure connection between the scan line 27 and the upper electrode 13. If focusing attention on both a joint interface of the scan line 27 and the connecting auxiliary layer 28 and a joint interface of the connecting auxiliary layer 28 and the upper electrode 13, a feature in which coarseness of the upper surface of the scan line 27 in the former is leveled in the upper surface of the connecting auxiliary layer 28 in the latter could be observed occasionally by an electron microscope etc.

The scan line 27 is formed by the screen printing method that uses, for example, Ag paste etc. as in the case of the first embodiment described above. Although baking of metal paste needs a step of heating up, structurally this step can be conducted prior to formation of the signal line 11 and the electron acceleration layer 12 made up of an Al thin film layer etc. Therefore, this structure can prevent these layers from being damaged by hillocks and void(s) caused by high temperatures.

The connecting auxiliary layer 28 is formed, for example, with Al or an Al alloy by the sputtering method to a thickness of 200-1000 nm.

The upper electrode 13 is a multilayer film with a thickness of 1-10 nm made by laminating, for example, Ir, Pt, and Au in this order.

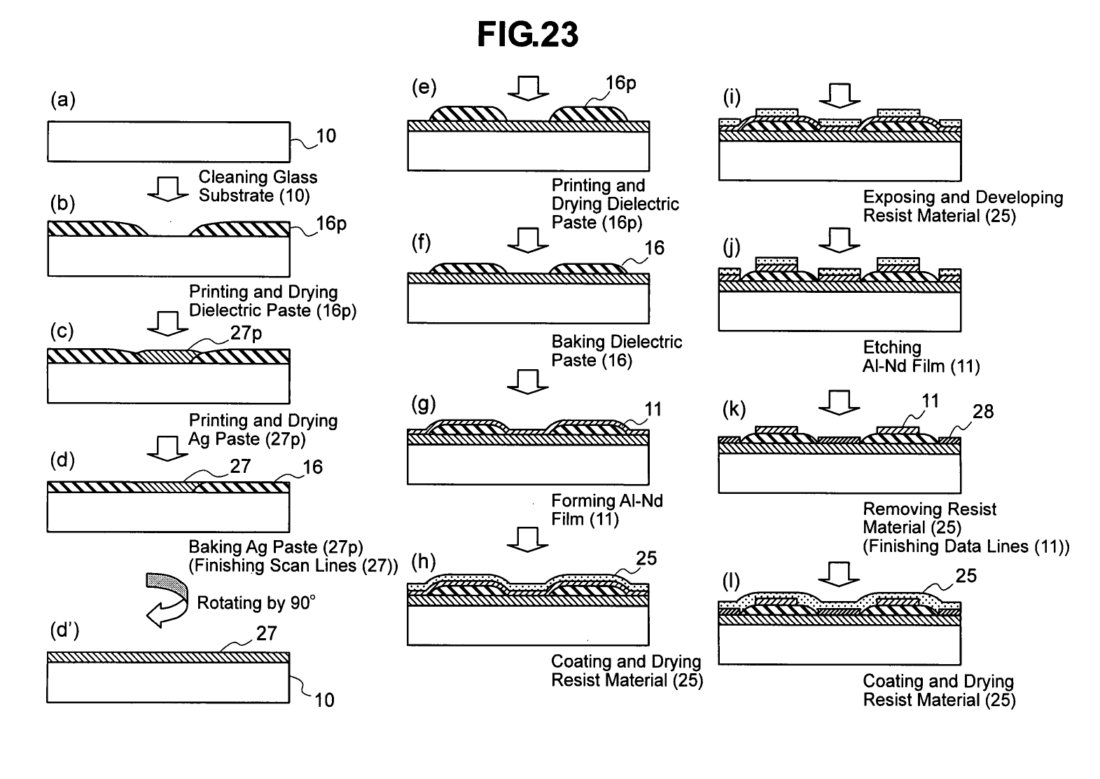

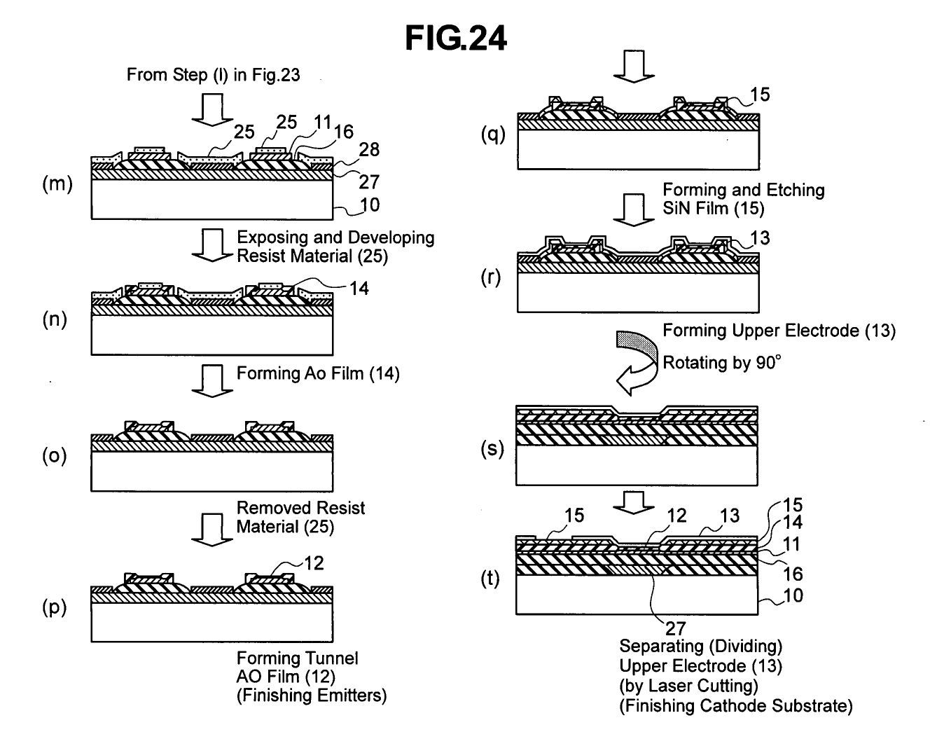

A manufacturing process of the cathode substrate 200 like this will be explained using FIGS. 23 and 24.

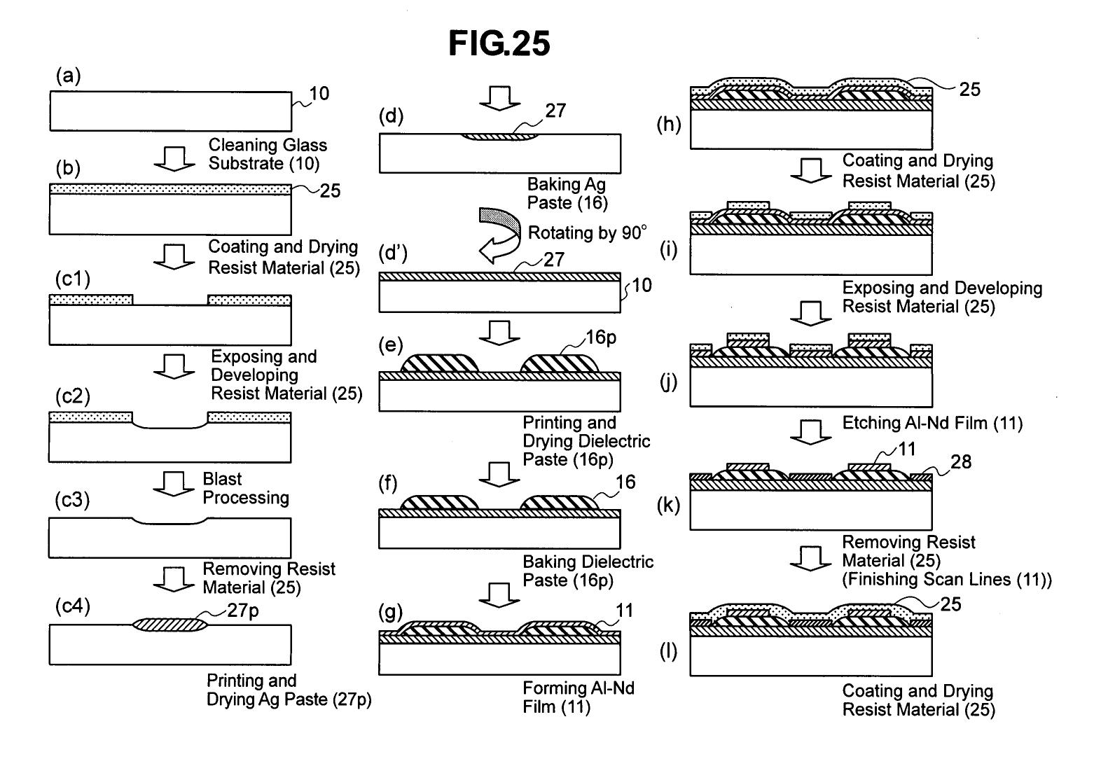

What is shown in Steps (a) to (d) of FIG. 23, Steps (s) and (t) of FIG. 24, and Step (t) is a part of cross section taken along line A-A′ of FIG. 21A. What is shown in Steps (d′) to (l) of FIG. 23 and Steps (m) to (r) of FIG. 25 is a part of a cross section taken along line B-B′ of FIG. 21A. Cross sections shown in Step (d) and in Step (d′) are for a structure at the same stage in the manufacturing process of this embodiment, each being drawn from a point of view different from the other by 90° (rotated by 90° on the principal surface of the substrate 10). Cross sections shown in Step (r) and Step (s) are drawn similarly.

First, the insulating substrates 10, such as of a glass, is cleaned (Step (a) of FIG. 23).

Next, dielectrics glass paste 16p is formed in the form of stripes in parallel to the scan lines with a screen printing machine and dried (Step (b) of FIG. 23).

Next, Ag paste 27p is made to fill between stripes of the dielectric paste with the screen printing machine, and baked after drying to form the scan line 27 (Steps (c) to (d) of FIG. 23). At this time, it is recommended to polish the surface to a smooth surface so that a layer that will be provided as an over layer (at an upper level) in a latter step may be formed properly.

Next, the dielectrics glass paste 16p was formed in the form of stripes running perpendicularly to the scan lines with the screen printing machine and dried (Step (e) of FIG. 23). Then, the stripe-formed dielectrics glass paste 16p is baked to form an insulating layer 16 (Step (f) of FIG. 23).

Next, the metal film 11 for the lower electrode was deposited (Step (g).of FIG. 23). As a lower electrode material, Al, Al alloys, etc. can be used. If Al or an Al alloy is used, a good-quality insulating layer can be formed on the surface of the metal film (lower electrode) 11 by subsequent anodic oxidation of the metal film 11. In this embodiment, an Al—Nd alloy with 2 atomic weight % of Nd doped in Al was used as the material of the metal film (lower electrode) 11. For example, the sputtering method is used for film formation of the metal film 11. The thickness of the metal film 11 is about 300 nm.

After film formation, the lower electrode 11 in the form of stripes is formed by a photolithography process and an etching process (Steps (h) to (k) of FIG. 23). In this embodiment, the lower electrode 11 serves as a signal-line side electrode. Moreover, other part of the metal film that was separated from the metal film 11 becoming the lower electrode and contacts the scan line 27 in Step (j) will serve as the connecting auxiliary layer 28.

Next, the first protective insulating layer 14 is formed (Step (1) of FIG. 23, Steps (m) to (o) of FIG. 24). Note that the first protective insulating layer 14 formed by anodic oxidation of the lower electrode 11 in Step (n) serves to control the electron emission part and prevent electric field concentration to the lower electrode edge.

In forming the first protective insulating layer 14, first, a part that will become the electron emission part on the lower electrode 11 is masked with the resist film. 25 (Step (m) of FIG. 24), and other part is anodized selectively thick (Step (n) of FIG. 24), which becomes the first protective insulating layer 14. For example, if the formation voltage is set to 100 V, the first protective insulating layer 14 about 136 nm thick will be formed.

Next, the electron acceleration layer 12 is formed (Step (p) of FIG. 24). That is, the resist film 25 is removed from the principal surface of the substrate 10 (Step (o) of FIG. 24), and a remaining surface of the lower electrode 11 is anodized, forming the electron acceleration layer 12. For example, if the formation voltage is set to 6 V, the electron acceleration layer 12 about 10 nm thick will be formed on the lower electrode 11.

Next, film formation and film processing of the second protective insulating layer 15 are conducted (Step (q) of FIG. 24.). That is, the second protective insulation film 15 is deposited by the sputtering method etc., and subsequently this film (its respective portions) is removed from an upper surface of the electron emission part (the electron acceleration layer 12) and an upper surface of the second connecting auxiliary layer 28, by dry-etching the upper surface thereof.

If the first protective insulating layer 14 formed by anodic oxidation has a pinhole, the second protective insulating layer 15 serves to embed the defect and maintain insulation between the lower electrode 11 and the upper bus electrode (scan line) 27. SiN etc. is used as the second protective insulating layer 15. The thickness of the second protective insulating layer 15 was chosen 40 nm.

In addition, if needed, the electron acceleration layer 12 is anodized again and damages produced in the electron acceleration layer 12 already formed in Step (p) of FIG. 24 are restored. It is recommended to conduct this processing on the substrate 10 when soaked in an electrolytic solution.

Next, film formation and film processing of the upper electrode 13 are conducted (Steps (r) to (t) of FIG. 24).

For deposition of the conducting film 13 that will become the upper electrodes, for example, the sputtering film forming method is used. As the upper electrode 13, a multilayer film made by laminating, for example, Ir, Pt, and Au in this order can be used. The thickness of the conducting film (upper electrode) 13 is 1-10 nm. In this embodiment, the thickness of the conducting film (upper electrode) 13 was chosen 3 nm. Then, a laser is used to separate the upper electrode 13 for each scan line 27. This structure enables the deposited thin upper electrode 13 to be supplied electric power from the scan line 27 through the connecting auxiliary layer 28.

The cathode substrate 200 manufactured in this way is combined with the anode substrate 100 like the first embodiment described above, and sealed. Then, the FED panel is finished.

The FED panel of the third embodiment and its manufacturing method were explained above.

According to this embodiment, there is provided the FED panel that has the scan lines whose thickness is sufficiently thick and whose resistance is thereby lowered. Therefore, this is an FED panel that can control the voltage and reduce brightness unevenness.

Moreover, even in the case where the scan line having a coarse surface is formed by the printing method etc. in order to form the scan lines in a thick film, since the connecting auxiliary layer for establishing conduction between the scan line and the upper electrode is provided between them, the structure enables the scan line to properly supply electric power to the upper electrode.

The scan lines are placed in a layer lower than the signal line and the electron acceleration layer. That is, the step of forming the scan lines by baking metal paste at a high temperature can be conducted prior to the step of forming the signal lines and the electron acceleration layer. By this procedural feature, it is possible to control hillocks and voids in the layer of the signal line and prevent damages of the electron acceleration layer.

### FOURTH EMBODIMENT

An FED panel of a fourth embodiment has a configuration similar to the FED panel of the third embodiment described above. Therefore, explanations for the configuration and manufacturing process common to the FED panel of the third embodiment may be omitted in some respects.

The FED panel of the fourth embodiment differs from the FED panel of the third embodiment in the configuration of the cathode substrate 200.

In the third embodiment, as shown in Steps (b) to (d) of FIG. 23, the dielectric paste 16p is formed on the substrate 10 in the form of stripes, and subsequently the paste 27p for the scan lines 27 is filled between the stripes of the dielectric paste 16p and baked to form the scan lines 27. On the contrary, in this embodiment, as shown in Steps (a) to (d) of FIG. 25, the substrate is subjected to blast processing to form a groove on the principal surface of the substrate 10 (Step (c2)), the paste 27p for the scan line 27 is filled in this groove,.and then the paste 27p is baked (Step (d)) to form the scan line 27.

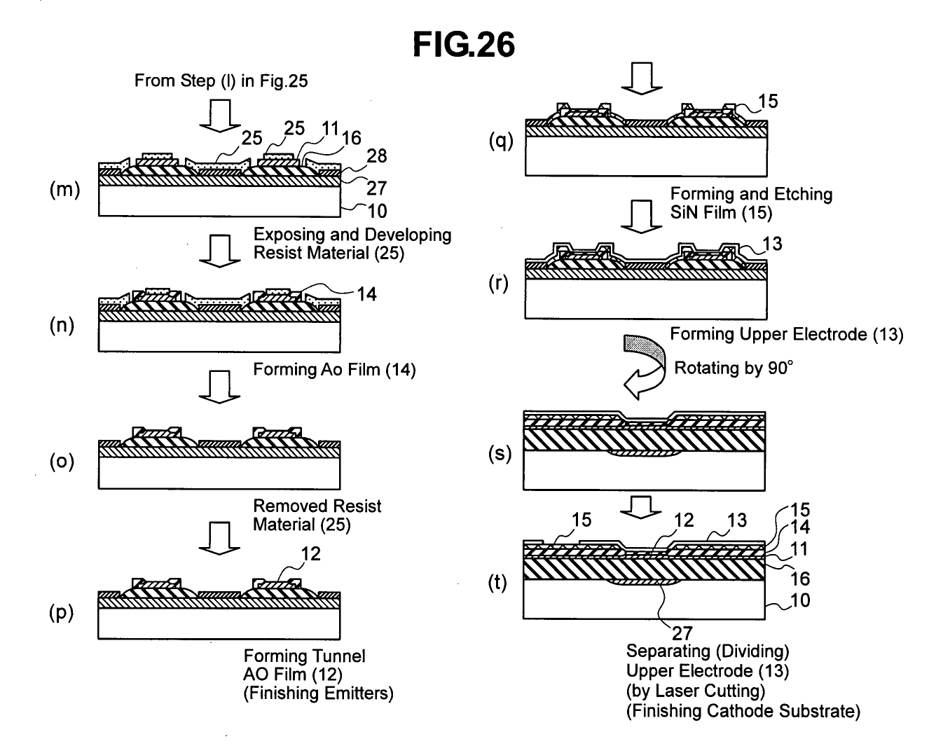

Hereafter, a manufacturing process of the cathode substrate 200 like this will be explained using FIGS. 25 and 26.

What is shown in Steps (a) to (d) of FIG. 25 and step (s) of FIG. 26 is a part of a cross section that is taken along line A-A′ of FIG. 21A. What is shown in Steps (d′) to (1) of FIG. 25 and Steps (m) and (r) of FIG. 26 is a part of a cross section that is taken along line B-B′ of FIG. 21A. Cross sections shown in Step (d) and in Step (d′) are for a structure at the same stage in the manufacturing process of this embodiment, each being drawn from a point of view different from the other by 90° (rotated by 90° in the principal surface of the substrate 10). Cross sections shown in Step (r) and in Step (s) are drawn similarly.

First, the insulating substrate 10, such as of a glass, is cleaned (Step (a) of FIG. 25).

Next, the blast-resistant resist 25 is coated on it with the screen printing machine and dried, and subsequently is processed in the form of stripes by etching (Step (c1) of FIG. 25). The thickness of the blast-resistant resist is about 10 μm.

Next, the substrate 10 is scraped with a sand blast machine to dig a groove, and after the digging the resist is removed (Steps (c2) to (c3) of FIG. 25). The depth of the dug part is about 25 μm.

Next, the Ag paste 27p is filled in the dug part in the form of stripes with the screen printing machine and dried to form the scan lines 27 (Steps (c4) to (d) of FIG. 25). Note that, in this process, it is preferable to polish and smooth the surface of the scan lines 27 so that a layer to be provided on the scan lines 27 in a latter step is properly formed.

Steps after this (Steps (e) to (1) of FIG. 25, and Steps (m) to (t) of FIG. 26) are the same as the steps of the third embodiment (Steps (e) to (1) FIG. 23, and Steps (m) to (t) of FIG. 24), and their-explanations are omitted.

The cathode substrate 200 manufactured in this way is combined with the anode substrate 100 like the first embodiment described above, and sealed. Thus the FED panel is finished.

According to this embodiment, there is provided the FED panel that has the scan lines whose thickness is sufficiently thick and whose resistance is thereby lowered. Therefore, this is an FED panel that can control a voltage drop and reduce brightness unevenness.

Moreover, even in the case where the scan line having a coarse surface is formed by the printing method etc. in order to form the scan lines in a thick film, since the connecting auxiliary-layer for establishing conduction between the scan line and the upper electrode is provided between them, the structure enables the scan line to properly supply electric power to the upper electrode.

The scan line is placed in a lower layer than the signal line and the electron acceleration layer. That is, a step of forming the scan line by baking metal paste at a high temperature can be conducted prior to a step of forming the signal line and the electron acceleration layer. This procedural feature can inhibit hillocks and voids of the signal line layer and prevent damages of the electron acceleration layer.

Moreover, since the scan line is provided in the groove dug into the substrate, the whole cathode substrate can be thinned.

Although several embodiments were explained above, this invention is not restricted to the embodiments described above, and various modifications can be possible within the spirit and scope of the invention.

For example, a diffusion prevention layer may be provided on the substrate 10 by means of SiO₂.coating etc. in order to prevent Na ion and K ion from diffusing from the substrate 10 made up of a glass etc.

For example, in the first embodiment and in the second embodiment, the diffusion prevention layer is provided between the substrate 10 and the signal line 11. In the third embodiment and in the forth embodiment, the diffusion prevention layer is provided between the substrate 10 and the scan line 27.

Although in the above-mentioned embodiments, the case where the electron source is of the MIM type was explained, taking it as an example, the above-mentioned embodiment can also be applied to an FED panel that uses an electron sources of other type. For example, this invention can also be applied to a display each of whose pixels is provided with a surface-conduction electron-emitter that is formed in such a way that a first electrode and a second electrode corresponding to the above-mentioned the lower electrode and the upper electrode, respectively, are placed on a same-level layer on the principal surface of the substrate and an insulation area is formed between the first electrode and the second electrode. In a display like this, the power supply line (bus electrode) to be electrically connected with either of the first electrode or the second electrode is formed in such a way as the above-mentioned scan line 27, and either of the first electrode or the second electrode and the power supply line are connected together using the connecting auxiliary layer 28, following either of the embodiments described above. In addition, in the display constructed in this way, the advantages of this invention described above are manifested.

While we have shown and described several embodiments in accordance with the present invention, it is understood that the same is not limited thereto but is susceptible of numerous changes and modifications as known to those skilled in the art, and we therefore do not wish to be limited to the details shown and described herein but intend to cover all such changes and modifications as are encompassed by the scope of the appended claims.

What is claimed is:

1. A display-panel of a display equipped with a plurality of electron sources on a substrate, comprising:
power supply lines for supplying electric power to electrodes of the electron source, wherein
a connecting auxiliary electrode for establishing connection between an electrode of the electron source and the power supply line is provided between the electrode and the power supply line.

2. A display panel of a display equipped with a plurality of electron sources on a substrate, wherein
the display panel has a structure in which a signal line, an insulating layer, a scan line, and a connecting auxiliary electrode are laminated in this order on the substrate,
and the connecting auxiliary electrode is in contact with an electrode of the electron source.

3. A display panel of a display equipped with a plurality of electron sources on a substrate, wherein
the display panel has a structure in which a signal line, an insulating layer, a scan line, and a connecting auxiliary electrode are laminated in this order on the substrate, and
the connecting auxiliary electrode connects an electrode of the electron source.

4. A display panel of a display equipped with a plurality of electron sources on a substrate, wherein
the display panel has a structure that has
a part in which-a scan line, an insulating layer, and a signal line are laminated in this order on the substrate and a part in which the scan line and a connecting auxiliary electrode are laminated in this order on the substrate, and
the connecting auxiliary electrode contacts with an electrode of the electron source.

5. The display panel of a display equipped with a plurality of electron sources on a substrate according to claim 4, wherein
the scan line is formed in a portion made by digging the substrate.

6. The display panel of a display equipped with a plurality of electron sources on a substrate according to claim 1, wherein
the power supply line is a layer formed by the screen printing method using metal paste, and
the connecting auxiliary electrode is a layer formed by the sputtering method.
